(19) United States
(12) Patent Application Publication
(10) Pub. No.: US 2013/0258843 A1
(43) Pub. Date: Oct. 3, 2013

(54) NETWORK SYSTEM AND APPARATIS

(71) Applicant: FUJITSU LIMITED, Kawasaki-shi (JP)

(72) Inventor: Toshihiko Kurita, Kawasaki (JP)

(73) Assignee: FUJITSU LIMITED, Kawasaki-shi (JP)

(21) Appl. No.: 13/670,642

(22) Filed: Nov. 7, 2012

(30) Foreign Application Priority Data
Mar. 29, 2012 (JP) 2012-077690

(51) Int. Cl. H04L 12/26; H04L 12/24

(52) U.S. Cl. 370/229; 370/241

(57) ABSTRACT

A network system includes a plurality of apparatuses which transmits traffic data included in a plurality of communications by switching a destination for each communication, and a management device coupled to the plurality of apparatuses, wherein each of the plurality of apparatuses includes, a processor which executes a first process including, selecting a communication from a plurality of communications, acquiring traffic data included in a selected communication selected in the selecting, and transmitting a acquired traffic data acquired in the acquiring to the management device, and wherein the management device includes a processor which executes a second process including receiving the acquired traffic data from each of the plurality of apparatuses, and performing an analysis of the selected communication based on the acquired traffic data.

### CROSS-REFERENCE TO RELATED APPLICATION

This application is based upon and claims the benefit of priority of the prior Japanese Patent Application No. 2012-77690, filed on Mar. 29, 2012, the entire contents of which are incorporated herein by reference.

### FIELD

The embodiments discussed herein are related to a network system and an apparatus.

### BACKGROUND

With a network system, a technique called sFlow has been employed as a technique to analyze traffic data which flows into the network thereof.

FIG. 1 is a diagram to describe a traffic data analyzing method according to sFlow. As illustrated in FIG. 1, each of node apparatuses 102 such as a server and switch devices and so forth, which make up a network system 100 includes an sFlow agent 104. Also, with the network system 100, there is provided a management device 106 to analyze traffic data which flows into the network thereof. The management device 106 includes an sFlow collector 108.

In the event of each of the node apparatuses 102 having received traffic data from another node apparatus, an sFlow agent 104 included in each of the node apparatuses 102 captures the received traffic data with a given certain ratio, thereby performing sampling of the traffic data. The sFlow agent 104 transmits the captured traffic data to the management device 106 as sampling data.

In the event of the management device 106 having received the captured traffic data from each of the node apparatuses 102, the sFlow collector 108 performs analysis of the header and payload of the received traffic data, thereby performing property analysis of the traffic. The management device 106 performs statistical processing based on the results of the property analysis thereof, thereby estimating a traffic tendency of the entire network system 100.

Note that, with regard to a specifying flow of traffic data which flows into a network, a technique to perform sampling of traffic data belonging to the corresponding flow in accordance with a given sampling condition has been described in Japanese Laid-open Patent Publication Nos. 2006-005402 and 2007-336512. Also, a technique to identify a flow to be measured by adding tag information to a packet that a server transmits has been described in Japanese Laid-open Patent Publication No. 2004-032714.

With a network system such as a large-scale data center network or the like, a large number of virtual machines (Virtual Machine: hereafter, also referred to as VM)) are provided to each of the servers making up the network. Connection is established between the virtual machines, a flow of traffic data is formed, and accordingly, the number of traffic data flows to be formed in the entire network becomes huge, and modes thereof also become various and complicated modes.

Therefore, with a network system such as a large-scale data center network or the like, in order to perform more precise traffic property analysis, there has been demand for each of the node apparatuses to perform property analysis of traffic data that flows into the network thereof on a per-flow basis to which the traffic data belongs.

With sFlow, received traffic data is captured at each of the node apparatuses with a certain ratio regardless of a flow to which traffic data belongs, and accordingly, the traffic data is not captured on a per-flow basis.

With sFlow, sampling of traffic data is performed independently at each of the node apparatuses, and accordingly, traffic data belonging to a particular flow is not traced across the entire network. Analysis such as comparison between the node apparatuses regarding traffic properties, or the like is not performed.

### SUMMARY

According to an aspect of the invention, a network system includes a plurality of apparatuses which transmits traffic data included in a plurality of communications by switching a destination for each communication, and a management device coupled to the plurality of apparatuses, wherein each of the plurality of apparatuses includes, a processor which executes a first process including, selecting a communication from a plurality of communications, acquiring traffic data included in a selected communication selected in the selecting, and transmitting a acquired traffic data acquired in the acquiring to the management device, and wherein the management device includes a processor which executes a second process including receiving the acquired traffic data from each of the plurality of apparatuses, and performing an analysis of the selected communication based on the acquired traffic data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a traffic data analyzing method according to sFlow of the related art;

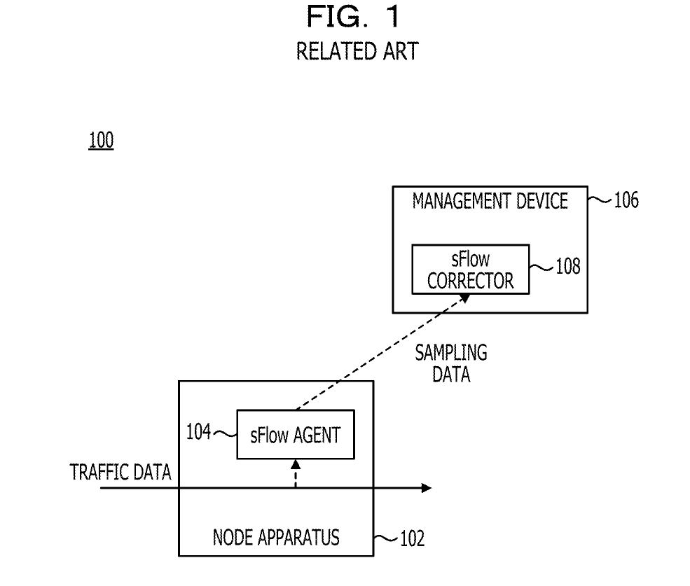

FIG. 2 is a diagram illustrating a configuration of a data center network system according to a first embodiment;

FIG. 3 is a function block diagram illustrating an internal configuration of a server and a switch device;

FIG. 4 is a function block diagram illustrating a configuration of a sampling management unit;

FIG. 5 is a table indicating an example of a connection management table;

FIG. 6 is a flowchart illustrating a method for determining a flow to be sampled at the sampling management unit;

FIG. 7 is a function block diagram illustrating a configuration of a sampling execution unit;

FIG. 8 is a table indicating an example of a flow-to-be-sampled table;

FIG. 9 is a flowchart illustrating a management method for a flow to be sampled a the sampling execution unit;

FIG. 10 is a flowchart illustrating a capture method of traffic data belonging to a flow to be sampled at the sampling execution unit;

FIG. 11 is a hardware configuration diagram illustrating an internal configuration of the server and switch device;

FIG. 12 is a diagram illustrating a configuration of a data center network system according to a second embodiment;

FIG. 13 is a function block diagram illustrating an internal configuration of a server;

FIG. 14 is a diagram indicating an example of marking information to be appended to traffic data;

FIG. 15 is a function block diagram illustrating a configuration of a sampling execution unit;

FIG. 16 is a flowchart illustrating a marking instructing method as to traffic data belonging to a flow to be sampled at the sampling execution unit;

FIG. 17 is a function block diagram illustrating an internal configuration of a switch device;

FIG. 18 is a flowchart illustrating a capture method for traffic data belonging to a flow to be sampled at the sampling execution unit;

FIG. 19 is a diagram illustrating an example of communication path switching processing in the event that congestion has occurred at the data center network; and

FIG. 20 is a diagram illustrating another example of communication path switching processing in the event that congestion has occurred at the data center network.

### DESCRIPTION OF EMBODIMENTS

Hereafter, embodiments of the present technology will be described. Note that, with the following embodiments, though description will be made with reference to a data center network system as a system example to which the present technology has been applied, the present technology is not restricted to this example, and may widely be applied to a network system including severs and switch devices and so forth.

### 1. First Embodiment

Hereafter, description will be made regarding a node apparatus and a network system, according to a first embodiment.

### 1-1. Configuration of Data Center Network System 200

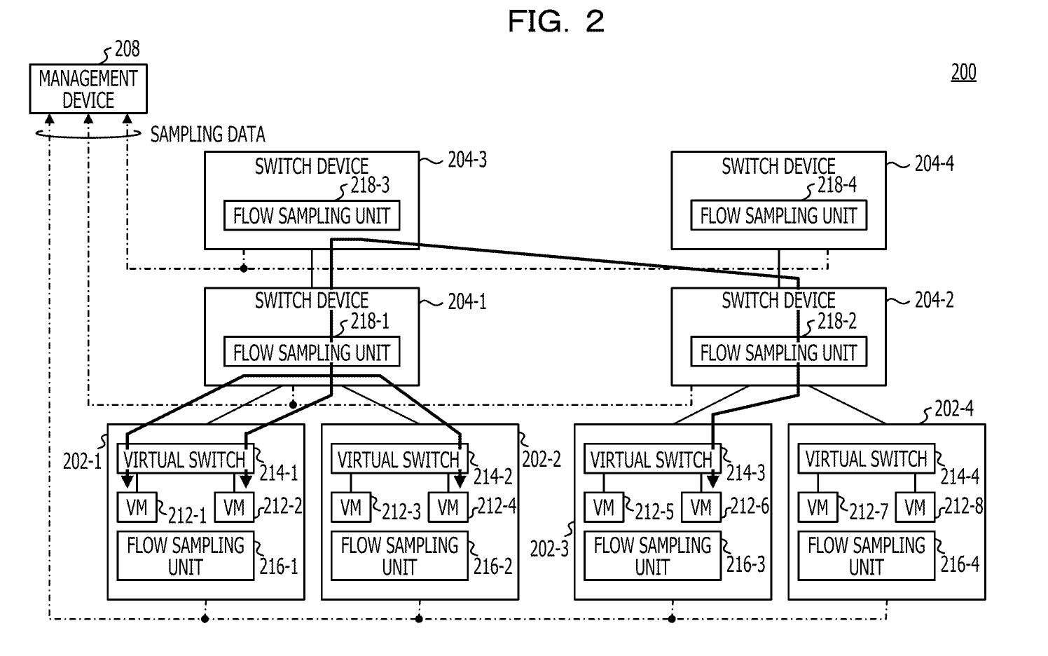

FIG. 2 is a diagram illustrating a configuration of a data center network system 200 according to the first embodiment.

As illustrated in FIG. 2, the data center network system 200 includes multiple node apparatuses including servers 202-1 to 202-4, switch devices 204-1 to 204-4, and a management device 208. The servers 202-1 to 202-4 and switch devices 204-1 to 204-4 are coupled via network lines for data communication illustrated in a solid line in FIG. 2.

Each of the servers 202-1 to 202-4 includes at least one virtual switch and multiple virtual machines (VM). For example, the server 202-1 includes one virtual switch 214-1 and two VMs 212-1 and 212-2. Each of the VMs 212-1 and 212-2 is coupled to the corresponding switch device 204-1 via the virtual switch 214-1. With the severs 202-2 to 202-4 as well, in the same way as with the server 202-1, multiple virtual machines 212-3 to 212-8 are coupled to the corresponding switch device 204-1/204-2 via the corresponding virtual switch 214-2/214-3/214-4.

The switch devices 204-1 to 204-4 are physical switches serving as network repeaters, and are layer 2 switches (L2 switches). Each of the switch devices 204-1 to 204-4 includes a forwarding information table in which forwarding information of traffic data is stored. The switch devices 204-1 to 204-4 perform widely-recognized switching control to receive traffic data from a server or another switch device, and to decide a transfer path of the received traffic data with reference to the forwarding information table based on the communication protocol of the layer 2 (data link layer).

The virtual switches 214-1 to 214-4 are virtually provided network repeaters to be realized by a processor at the corresponding server executing a given program, and are layer 2 (L2) switches. Each of the virtual switches 214-1 to 214-4 includes, in the same way as with the switch devices 204-1 to 204-4, a forwarding information table in which forwarding information of traffic data is stored. The virtual switches 214-1 to 214-4 perform switching control to receive traffic data from a VM or switch device, and to decide a transfer path of the received traffic data with reference to the forwarding information table based on the communication protocol of the layer 2 (data link layer).

Each of the VMs 212-1 to 212-8 establishes connection with another VM, and performs communication of traffic data with the VM with which the connection has been established. In the event that connection has been established between two VMs, a communication path to pass through the corresponding virtual switch of the virtual switches 214-1 to 214-4 and at least one of the switch devices 204-1 to 204-4 is established between the two VMs thereof. Each communication path is established as a result of the above-mentioned switching control being executed at each of the switch devices and virtual switches positioned on the communication path thereof.

Traffic data belonging to the corresponding flow is transferred between the two VMs thereof using the established communication path. Here, the flow mentioned here is a series of traffic data aggregate to be subjected to communication control as an integrated data group based on a communication protocol such as TCP (Transmission Control Protocol), UDP (User Datagram Protocol) or the like.

With the example illustrated in FIG. 2, connection is established between the VM 212-1 and VM 212-4, and a communication path passing through the virtual switch 214-1, switch device 204-1, and virtual switch 214-2 is established between the VM 212-1 and VM 212-4 as illustrated with a heavy solid line. Traffic data belonging to the corresponding flow is transferred between the VM 212-1 and VM 212-4 using the established communication path.

Also, connection is established between the VM 212-2 and VM 212-6, and a communication path passing through the virtual switch 214-1, switch devices 204-1, 204-3, and 204-2, and virtual switch 214-3 is established between the VM 212-2 and VM 212-6 as illustrated with a heavy solid line. Traffic data belonging to a flow different from the flow between the VM 212-1 and VM 212-4 is transferred between the VM 212-2 and VM 212-6 using the established communication path.

Further, with the data center network system 200, the servers 202-1 to 202-4 include flow sampling units 216-1 to 216-4, respectively. The switch devices 204-1 to 204-4 include flow sampling units 218-1 to 218-4, respectively.

The flow sampling units 216-1 to 216-4 receive traffic data generated by the corresponding two VMs of the VMs 212-1 to 212-8, and stochastically decide a flow to be sampled based on flow control data included in the received traffic data. The flow sampling units 216-1 to 216-4 acquire all of traffic data belonging to the flow decided to be sampled (flow to be sampled)by capturing, and outputs the captured traffic data to the management device 208 as sampling data. Details regarding the flow sampling units 216-1 to 216-4 and flow control data will be described later.

The flow sampling units 218-1 to 218-4 receive traffic data from the servers 202-1 to 202-4 or switch devices 204-1 to 204-4 other than the own device, and stochastically decide whether to determine the received traffic data to be sampled based on flow control data included in the received traffic data. The flow sampling units 218-1 to 218-4 capture all of traffic data belonging to the flow to be sampled, and output the captured traffic data to the management device 208 as sampling data. Details regarding the flow sampling units 218-1 to 218-4 and flow control data will be described later.

The management device 208 is coupled to the servers 202-1 to 202-4, and switch devices 204-1 to 204-4 via a network line for management illustrated in a dashed-dotted line in FIG. 2. The network lines for management illustrated in a dashed-dotted line are lines independent from the network lines for data communication illustrated in a solid line. The management device 208 receives sampling data from each of the servers 202-1 to 202-4 and switch devices 204-1 to 204-4 via a network line for management.

The management device 208 performs analysis of the header and payload of the received sampling data, thereby executing flow property analysis regarding the flow to be sampled. Examples of flow property analysis include analysis of parameters regarding performance of the flow thereof, analysis regarding a flow rate, a loss rate and the number of times of retransmissions of traffic data belonging to the flow thereof, and TCP sequence analysis regarding traffic data belonging to the flow thereof.

The management device 208 continues reception of sampling data from the servers 202-1 to 202-4 and switch devices 204-1 to 204-4 while the data center network system 200 is activated. The management device 208 continuously receives sampling data from each of the servers or switch devices during an activation period of the data center network system 200 in a periodical manner, thereby accumulating the sampling data from each of the servers or switch devices.

The management device 208 performs statistical processing on the property analysis results of the flow to be sampled based on each of accumulated sampling data, thereby obtaining statistical information indicating a traffic tendency on a per-flow basis regarding the data center network system 200. Details of processing to be performed at the management device 208 will be described later.

As described above, with the network system 200 according to the first embodiment, the servers 202 and switch devices 204 making up the network system capture all of traffic data belonging to a flow to be sampled on a per-flow basis, and transmit the captured traffic data to the management device 208 as sampling data, and accordingly, the management device 208 may execute traffic property analysis on a per-flow basis based on a series of sampling data belonging to the one flow, and may obtain the analysis results of parameters (the flow rate, loss rate, and the number of timed of retransmissions of the flow) regarding the performance of the flow. Further, the management device 208 may estimate a traffic tendency of the entire data center network system 200 as a traffic tendency on a per-flow basis using the statistical processing of the analysis results thereof.

Note that, with the data center network system 200 illustrated in FIG. 2, though the flow sampling units 216-1 to 216-4 and 218-1 to 218-4 are provided to the servers 202-1 to 202-4 and switch devices 204-1 to 204-4 making up the system respectively, the present technology is not restricted to this configuration. The flowing sampling unit may be provided to some devices alone selected out of the servers 202-1 to 202-4 and switch devices 204-1 to 204-4, and for example, an arrangement may be made wherein the flow sampling units 216-1 to 216-4 are provided to the servers 202-1 to 202-4 alone respectively, and no flow sampling unit is provided to the switch devices 204-1 to 204-4.

### 1-2. Internal Configuration of Server Device 202 and Switch Device 204

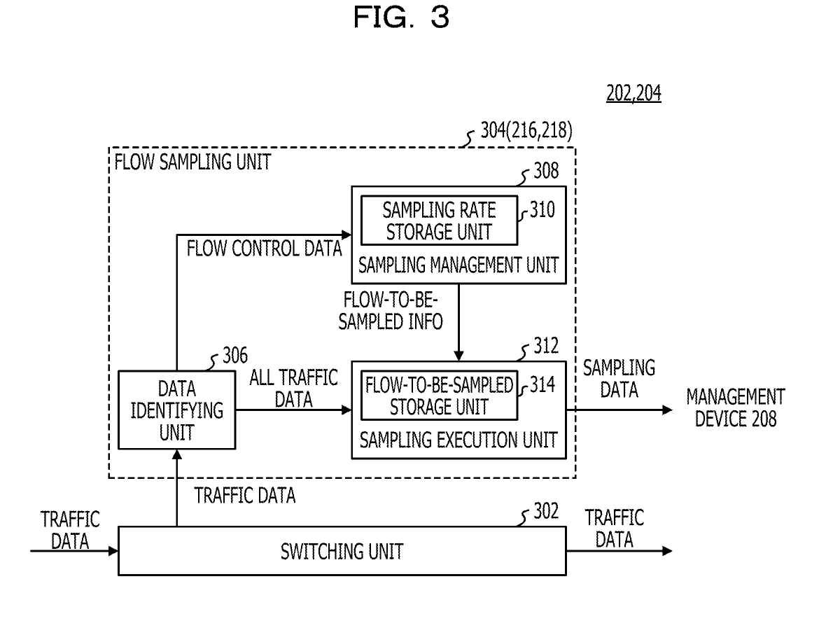

FIG. 3 is a function block diagram illustrating an internal configuration of the servers 202 and switch devices 204. FIG. 3 illustrates portions relating to the switching control function and flow sampling function of traffic data of the functions that the servers 202 and switch devices 204 have, and these functions are mutually similar at the servers 202 and switch device 204. Accordingly, the servers 202 and switch devices 204 will collectively be described with reference to FIG. 3.

As illustrated in FIG. 3, the servers 202 and switch devices 204 include a switching unit 302 and a flow sampling unit 304.

The switching unit 302 receives traffic data, and internally holds the received traffic data. The switching unit 302 outputs all of the received traffic data to a data identifying unit 306 within the flow sampling unit 304.

The switching unit 302 includes a forwarding information table (not illustrated) in which forwarding information of traffic data is stored. The switching unit 302 performs widely-recognized switching control to decide a transfer path of the traffic data held therein with reference to the forwarding information table based on the communication protocol of the layer 2 (data link layer).

With the servers 202, the switching unit 302 receives traffic data from the VMs 212 provided within the servers 202, and outputs the received traffic data to the switch device 204 decided by switching control. The switching unit 302 corresponds to the virtual switches 214 provided to the inner portions of the servers 202.

With the switch devices 204, the switching unit 302 receives traffic data from the virtual switches 214 provided to the servers 202 or another switch device 204 via a network line for data communication, and outputs the received traffic data to another switch device 204 or the virtual switch 214 provided to the server 202, decided by switching control.

As illustrated in FIG. 3, the flow sampling unit 304 includes a data identifying unit 306, a sampling management unit 308, and a sampling execution unit 312. The flow sampling unit 304 corresponds to the flow sampling units 216 and 218 illustrated in FIG. 2.

The data identifying unit 306 receives traffic data from the switching unit 302. The data identifying unit 306 identifies whether or not the received traffic data is data (flow control data) including connection control information of a flow to which the traffic data thereof belongs (flow connection control information). The data identifying unit 306 outputs, in the event that the received traffic data is flow control data, the flow control data thereof (traffic data) to the sampling management unit 308.

The above-mentioned flow connection control information is information to control start or end of the flow thereof, for example. In the event of a flow to be controlled based on TCP, the flow connection control information is a SYN flag and a FIN flag included in the TCP header of traffic data, for example. The SYN flag is a flag indicating a start request for TCP connection, included in the TCP header. The FIN flag is a flag indicating an end request for TCP connection, included in the TCP header.

Also, the data identifying unit 306 outputs all of the received traffic data to the sampling execution unit 312.

The sampling management unit 308 includes a sampling rate storage unit 310, and receives flow control data from the data identifying unit 306. The sampling rate storage unit 310 is a storage unit configured to store a sampling rate to be used for deciding a flow to be sampled. The sampling rate is a value to be set beforehand. The sampling management unit 308 stochastically decides, in the event that the received flow control data includes flow connection control information indicating start of a flow, whether or not the flow thereof is to be taken as a flow of traffic data to be sampled, in accordance with the sampling rate stored in the sampling rate storage unit 310.

The sampling management unit 308 obtains, in the event that the flow corresponding to the received flow control data has been decided to be sampled, flow-specific identification information to identify a flow (flow identification information) from the received flow control data. Examples of the flow identification information to be obtained include a MAC (Media Access Control) address, an IP (Internet Protocol) address, and a port number, which indicate a transmission source and a destination.

The sampling management unit 308 generates flow-to-be-sampled information including the obtained flow identification information, and outputs the generated flow-to-be-sampled information to the sampling execution unit 312. Details for the sampling management unit 308 will be described later.

The sampling execution unit 312 includes a flow-to-be-sampled storage unit 314, and receives flow-to-be-sampled information from the sampling management unit 308. The flow-to-be-sampled storage unit 314 is a storage unit configured to store flow identification information relating to a flow to be sampled. The sampling execution unit 312 stores flow identification information included in the received flow-to-be-sampled information in the flow-to-be-sampled storage unit 314.

The sampling execution unit 312 receives all of the traffic data received at the switching unit 302 from the data identifying unit 306. The sampling execution unit 312 determines whether or not each received traffic data is data belonging to a flow to be sampled, with reference to flow identification information relating to a flow to be sampled, stored in the flow-to-be-sampled storage unit 314.

The sampling execution unit 312 obtains flow identification information relating to a flow to which the received traffic data belongs, with reference to the TCP header included in the received traffic data, for example. The sampling execution unit 312 compares the obtained flow identification information, and flow identification information relating to a flow to be sampled, stored in the flow-to-be-sampled storage unit 314, and in the event that both are in agreement, determines that the received traffic data is data belonging to a flow to be sampled.

The sampling execution unit 312 captures, in the event that the received traffic data is data belonging to a flow to be sampled, the traffic data thereof. The sampling execution unit 312 outputs the captured traffic data to the management device 208 illustrated in FIG. 2 via a network line for management as sampling data. Details for the sampling execution unit 312 will be described later.

As described above, with the servers 202 and switch devices 204 according to the first embodiment, an arrangement may be made wherein all of traffic data belonging to a flow to be sampled are captured on a per-flow basis, and the captured traffic data is transmitted to the management device 208 as sampling data.

### 1-3. Sampling Management Unit 308

### 1-3-1. Configuration of Sampling Management Unit 308

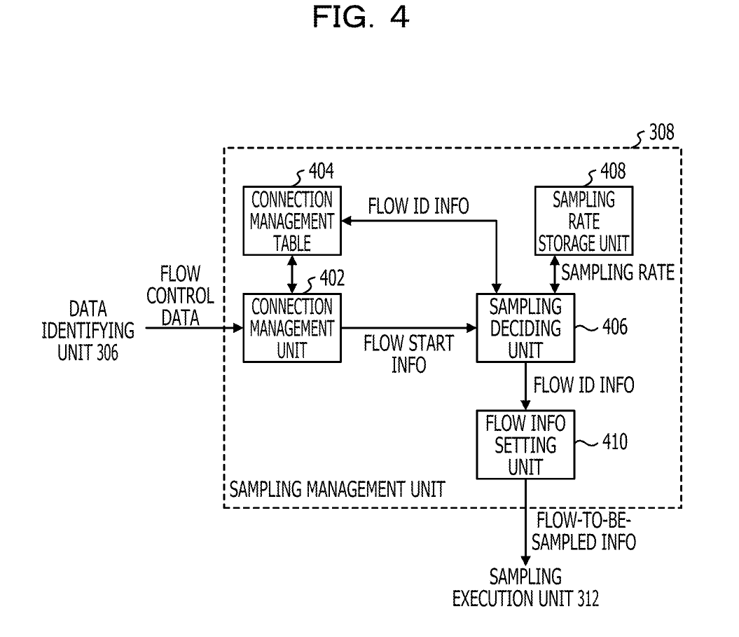

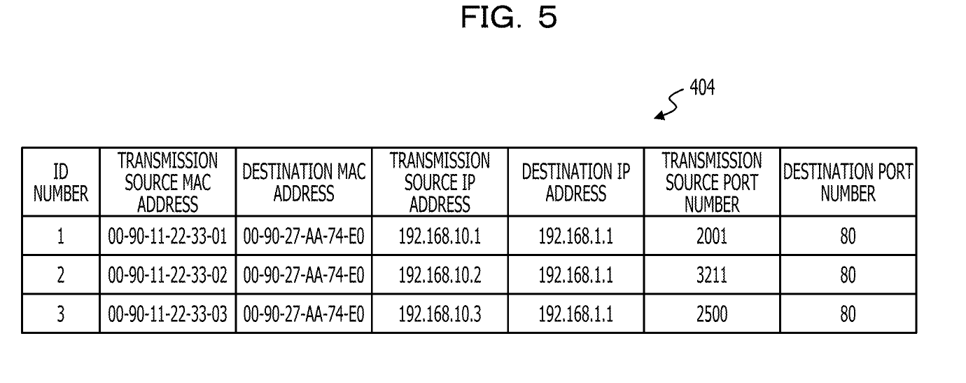

FIG. 4 is a function block diagram illustrating a configuration of the sampling management unit 308. FIG. 5 is a diagram indicating an example of a connection management table 404.

As illustrated in FIG. 4, the sampling management unit 308 includes a connection management unit 402, the connection management table 404, a sampling deciding unit 406, a sampling rate storage unit 408, and a flow information setting unit 410.

The connection management unit 402 receives flow control data from the data identifying unit 306. The connection management unit 402 obtains flow connection control information included in the received flow control data. The flow connection control information is, as described above, information to control start or end of the flow thereof, for example. In the event of a flow to be controlled based on TCP, the flow connection control information is a SYN flag and a FIN flag included in the TCP header of traffic data, for example.

The connection management unit 402 determines whether or not the obtained flow connection control information indicates start or end of the flow. The connection management unit 402 further obtains, in the event that the obtained flow connection control information indicates start or end of the flow, flow identification information from the received flow control data.

The connection management unit 402 confirms, in the event that the obtained flow connection control information indicates start of a flow, that the new flow is started, and stores the obtained flow identification information in a given entry of the connection management table 404.

The connection management table 404 is a storage unit configured to store flow identification information regarding the flow to be newly started, obtained by the connection management unit 402. As indicated in FIG. 5, with the connection management table 404, flow identification information including a plurality of identification information made up of, for example, a transmission source MAC address, a destination MAC address, a transmission source IP address, a destination IP address, a transmission source port number, and a destination port number is stored by being divided into multiple entries. Each of the flows is identified by all of or a part of combinations of a plurality of identification information included in the corresponding flow identification information.

Also, the connection management unit 402 generates, in the event that the obtained flow connection control information indicates start of a flow, flow start information that indicates that there is a flow to be newly started. The flow start information includes determination information of a flow to be newly started. The determination information of a flow to be newly started is, for example, information of an entry identification number in the connection management table 404 indicated in FIG. 5. The connection management unit 402 informs the generated flow start information to the sampling deciding unit 406.

The connection management unit 402 confirms, in the event that the obtained flow connection control information indicates end of a flow, that there is a flow to be ended out of existing flows, and deletes the entry where the obtained flow identification information is stored, from the connection management table 404.

Note that the connection management unit 402 may perform, instead of deleting an entry corresponding to the obtained flow identification information, processing to inactivate the entry thereof. The connection management unit 402 manages a flow where transfer of traffic data is being continued by managing the entry of flow identification information at the connection management table 404.

The sampling deciding unit 406 receives flow start information from the connection management unit 402. The sampling deciding unit 406 references, when receiving the flow start information, the connection management table 404 based on the flow determination information included in the received flow start information. Thus, the sampling deciding unit 406 obtains flow identification information regarding a flow to be newly started.

Also, the sampling deciding unit 406 obtains, when receiving flow start information, information of the sampling rate stored in the sampling rate storage unit 408 with reference to the sampling rate storage unit 408. The sampling deciding unit 406 stochastically decides whether or not the flow to be newly started is to be taken as a flow to be sampled of traffic data, in accordance with a probability to be decided by the obtained sampling rate.

The sampling rate storage unit 408 corresponds to the sampling rate storage unit 310 illustrated in FIG. 3, and is a storage unit configured to store a sampling rate to be used at the time of deciding a flow to be sampled. The sampling rate mentioned here is a value representing a probability that sampling will be executed on the corresponding flow when the sampling deciding unit 406 receives the above-mentioned flow start information, and is a value indicating a ratio of the number of flows where sampling will be carried out, as to the number of all flows to be started within a certain period of time. The sampling rate is provided as a fixed value (constant).

Various methods may be conceived as a method to stochastically decide a flow to be sampled in accordance with the sampling rate at the sampling deciding unit 406.

As one exemplification method, the sampling deciding unit 406 includes a random number generator configured to randomly generate a given hit value in accordance with a probability to be decided by the obtained sampling rate. The sampling deciding unit 406 then generates a random number value using the random number generator which generates an integer of 1 to N with an equal probability each time flow start information is received, and when the randomly generated random number value is coincided with the above-mentioned hit value, decides a flow corresponding to the flow start information thereof to be a flow to be sampled of traffic data. For example, in the event that the sampling rate is “1/N” (N is a positive integer), “1” is determined to be a hit value beforehand, and when the random number value generated by the random number generator is “1”, the sampling deciding unit 406 decides a flow corresponding to the flow start information to be a flow to be sampled.

Or, as another method, the sampling deciding unit 406 may decide, when receiving flow start information, a flow corresponding to the flow start information thereof to be a flow to be sampled with a ratio of once out of the number of times equivalent to the reciprocal number of the sampling rate. For example, in the event that the sampling rate is “1/N” (N is a positive integer), the sampling deciding unit 406 counts the number of times of receiving flow start information. The sampling deciding unit 406 decides, each time the count number reaches a multiple of N equivalent to the reciprocal number of the sampling rate, a flow corresponding to the flow start information at that time to be a flow to be sampled.

Or, as another method, the sampling deciding unit 406 may provide a sampling period as a part of a fixed monitoring period based on the sampling rate, and decide a flow corresponding to a flow start signal received for the sampling period thereof to be flow to be sampled. For example, in the event that the sampling rate is “1/N” (N is a positive integer), the sampling deciding unit 406 decides the monitoring period to be for N seconds, and decides the sampling period to be for one second within the N-second monitoring period. The sampling deciding unit 406 then decides a new flow corresponding to flow start information received within the determined one-second sampling period to be a flow to be sampled. Note that whether to set the one-second sampling period at which timing of the entire N seconds may be randomly be selected.

The sampling deciding unit 406 outputs, in the event that a new flow corresponding to the received flow start information has been decided to be a flow to be sampled, the obtained flow identification information to the flow information setting unit 410 as flow identification information regarding the flow to be sampled.

The flow information setting unit 410 receives flow identification information from the sampling deciding unit 406. The flow information setting unit 410 generates flow-to-be-sampled information including flow identification information regarding the flow to be sampled, based on the received flow identification information. The flow information setting unit 410 outputs the generated flow-to-be-sampled information to the sampling execution unit 312.

As described above, with the sampling management unit 308 according to the first embodiment, the sampling deciding unit 406 stochastically decides, in response to flow start information, a flow to be sampled in accordance with a probability decided with the sampling rate, and accordingly, traffic data may be captured as sampling data on a per-flow basis without increasing the number of data to be sampled at each of the servers 202 and switch devices 204, and also without deteriorating random nature as the entire sampling data to be used for statistical processing.

### 1-3-2. Method to Decide Flow to Be Sampled

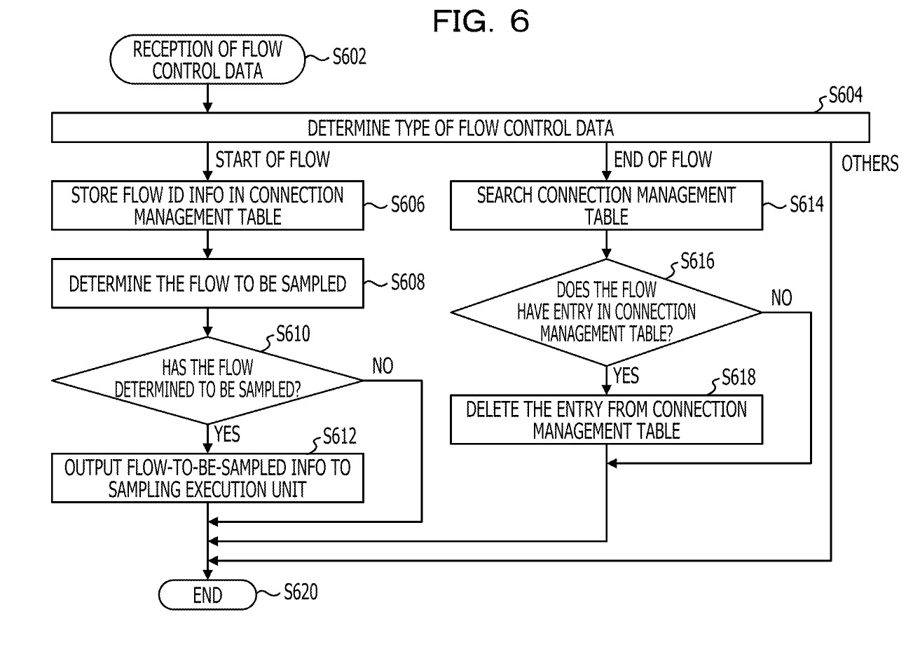

FIG. 6 is a flowchart illustrating a method to decide a flow to be sampled, to be executed at the sampling management unit 308. Hereafter, description will be made regarding the method to decide a flow to be sampled, to be executed at the sampling management unit 308, with reference to FIG. 4 in addition to FIG. 6.

As illustrated in FIG. 6, in step S602, the connection management unit 402 receives flow control data from the data identifying unit 306. According to reception of the flow control data, a series of processing to decide a flow to be sampled is started.

Next, in step S604, the connection management unit 402 obtains flow connection control information from the flow control data received in step S602. The connection management unit 402 determines whether the obtained flow connection control information indicates star or end of the flow. When the obtained flow connection control information indicates start of the flow, the processing proceeds to step S606. When the obtained flow connection control information indicates end of the flow, the processing proceeds to step S614. When the obtained flow connection control information indicates contents other than start nor end, the processing proceeds to step S620.

In step S606, the connection management unit 402 obtains flow identification information from the flow control data received in step S602. The connection management unit 402 stores the obtained flow identification information in a given entry in the connection management table 404. Also, the connection management unit 402 informs flow start information including determination information of the flow to be newly started to the sampling deciding unit 406. Examples of the determination information of the flow to be newly started include information of an entry identification number in the connection management table 404 indicated in FIG. 5.

Next, in step S608, the sampling deciding unit 406 stochastically decides, in response to reception of the flow start information, whether or not a flow corresponding to the flow start information is to be taken as a flow to be sampled, in accordance with a probability decided with the sampling rate. The sampling rate employed here is obtained by referencing the sampling rate storage unit 408. The method to stochastically decide a flow to be sampled in accordance with the sampling rate is as having mentioned above.

Next, in the event that decision is made in step S610 that the flow corresponding to the flow start information is to be taken as a flow to be sampled, the processing proceeds to step S612. On the other hand, in the event that decision is made that the flow corresponding to the flow start information is not taken as a flow to be sampled, the processing proceeds to step S620.

In step S612, the sampling deciding unit 406 outputs the flow identification information obtained in step S606 to the flow information setting unit 410 as the flow identification information of the flow to be sampled. The flow information setting unit 410 generates flow-to-be-sampled information including the flow identification information received from the sampling deciding unit 406, and outputs the generated flow-to-be-sampled information to the sampling execution unit 312.

Next, in step S620, the series of processing to decide a flow to be sampled is ended.

On the other hand, in step S614, the connection management unit 402 obtains flow identification information from the flow control data received in step S602. The connection management unit 402 searches the connection management table 404 based on the obtained flow identification information to confirm whether or not there is an entry where the obtained flow identification information is stored out of the connection management table 404.

Next, in step S616, in the event that there is an entry where the obtained flow identification information is stored out of the connection management table 404, the processing proceeds to step S618. On the other hand, in the event that there is no entry where the obtained flow identification information is stored out of the connection management table 404, the processing proceeds to step S620.

In step S618, the connection management unit 402 deletes the entry where the flow identification information obtained in step S614 is stored, from the connection management table 404.

### 1-4. Sampling Execution Unit 312

### 1-4-1. Configuration of Sampling Execution Unit 312

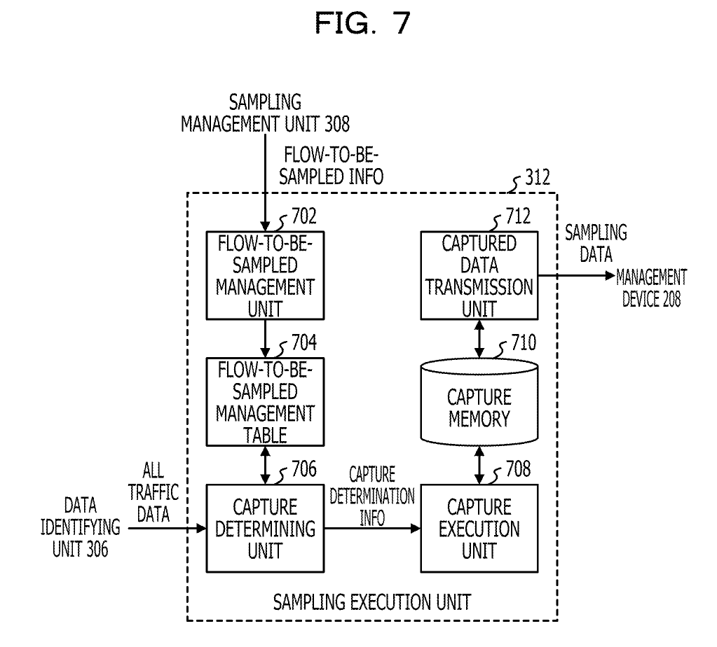

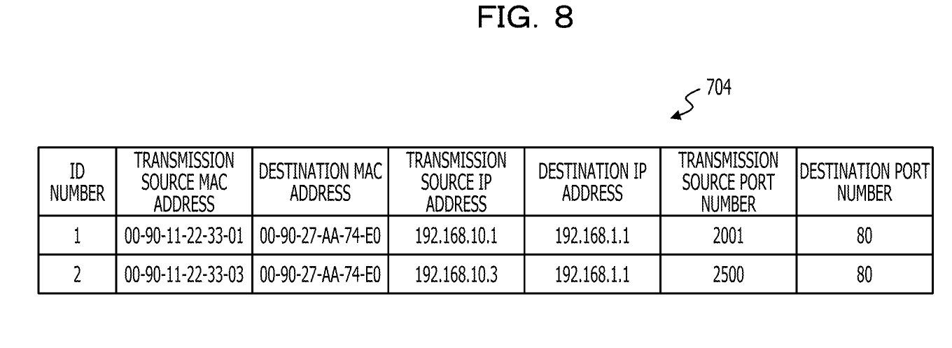

FIG. 7 is a function block diagram illustrating a configuration of the sampling execution unit 312. FIG. 8 is a diagram indicating an example of the flow-to-be-sampled management table 704.

As illustrated in FIG. 7, the sampling execution unit 312 includes a flow-to-be-sampled management unit 702, the flow-to-be-sampled management table 704, a capture determining unit 706, a capture execution unit 708, capture memory 710, and a captured data transmission unit 712.

The flow-to-be-sampled management unit 702 receives flow-to-be-sampled information from the flow information setting unit 410 within the sampling management unit 308. The flow-to-be-sampled management unit 702 obtains flow identification information regarding a flow to be sampled, based on the received flow-to-be-sampled information. The flow-to-be-sampled management unit 702 stores the obtained flow identification information regarding the flow to be sampled, in a given entry in the flow-to-be-sampled management table 704. The flow-to-be-sampled management unit 702 manages which flow has become the flow to be sampled, by managing the entries of flow identification information at the flow-to-be-sampled management table 704.

The flow-to-be-sampled management table 704 corresponds to the flow-to-be-sampled storage unit 314 illustrated in FIG. 3, and is a storage unit configured to store flow identification information regarding a flow to be sampled. As indicated in FIG. 8, with the flow-to-be-sampled management table 704, flow identification information including a plurality of identification information made up of, for example, a transmission source MAC address, a destination MAC address, a transmission source IP address, a destination IP address, a transmission source port number, and a destination port number is stored by being divided into multiple entries. Each of the flows to be sampled is identified by all of or a part of combinations of a plurality of identification information included in the corresponding flow identification information.

The capture determining unit 706 receives all of the traffic data received at the switching unit 302 from the data identifying unit 306. The capture determining unit 706 determines whether or not each of the received traffic data is data belonging to a flow to be sampled by referencing each of the entries stored in the flow-to-be-sampled management table 704, based on the received traffic data.

The capture determining unit 706 obtains flow identification information of a flow to which the received traffic data belongs with reference to the MAC header, IP header, and TCP header included in the received traffic data. The capture determining unit 706 compares the obtained flow identification information and flow identification information stored in each of the entries in the flow-to-be-sampled management table 704. The capture determining unit 706 determines, as a comparison result, in the event that both are in agreement, that the received traffic data is data belonging to a flow to be sampled.

The capture determining unit 706 determines, in the event that the received traffic data is data belonging to a flow to be sampled, that the traffic data thereof is data to be captured, and generates capture determination information. The capture determination information indicates that the traffic data thereof is data to be captured. The capture determining unit 706 outputs the generated capture determination information and the corresponding traffic data to the capture execution unit 708.

The capture execution unit 708 receives the capture determination information and the corresponding traffic data from the capture determining unit 706. The capture execution unit 708 captures, in response to the capture determination information, the received traffic data, and writes the captured traffic data in the capture memory 710. The capture memory 710 is a storage unit configured to store traffic data captured by the capture execution unit 708.

The captured data transmission unit 712 periodically monitors whether or not new traffic data is written in the capture memory 710 with reference to data stored in the capture memory 710. The captured data transmission unit 712 reads out, in the event that there is traffic data newly written in the capture memory 710, the new traffic data thereof from the capture memory 710. The captured data transmission unit 712 transmits the read traffic data to the management device 208 illustrated in FIG. 2 via a network line for management as sampling data.

As described above, with the sampling execution unit 312 according to the first embodiment, the capture determining unit 706 suitably filters traffic data alone belonging to a flow to be sampled, out of all of the traffic data, and accordingly, the capture execution unit 708 may capture traffic data alone belonging to a flow to be sampled, on a per-flow basis, and transmit the captured traffic data to the management device 208 as sampling data.

### 1-4-2. Traffic Data Sampling Execution Method

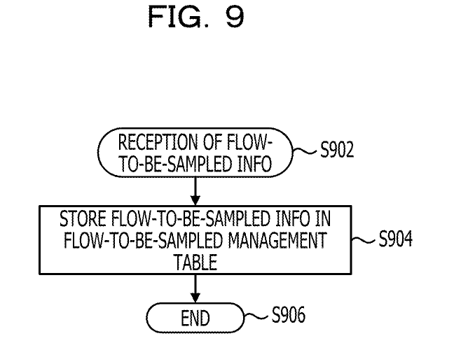

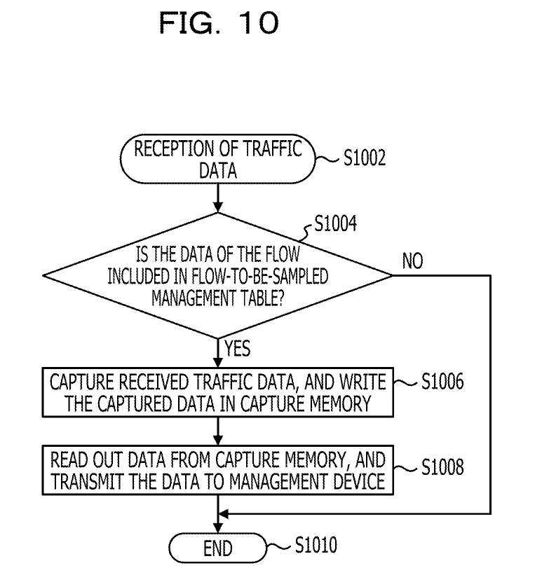

FIGS. 9 and 10 are flowcharts illustrating a sampling execution method of traffic data belonging to a flow to be sampled, to be executed at the sampling execution unit 312. FIG. 9 is a flowchart illustrating a management method of a flow to be sampled, of a sampling execution method. FIG. 10 is a flowchart illustrating a capture method of traffic data belonging to a flow to be sampled, in the sampling execution method.

Hereafter, description will be made regarding a method to decide a flow to be sampled, to be executed at the sampling execution unit 312, with reference to FIG. 7 in addition to FIGS. 9 and 10.

As illustrated in FIG. 9, in step S902, the flow-to-be-sampled management unit 702 receives flow-to-be-sampled information from the flow information setting unit 410 within the sampling management unit 308. According to reception of the flow-to-be-sampled information, a series of processing to manage a flow to be sampled is started.

Next, in step S904, the flow-to-be-sampled management unit 702 stores flow identification information regarding a flow to be sampled in a given entry of the flow-to-be-sampled management table 704 based on the flow-to-be-sampled information received in step S902. The flow-to-be-sampled management unit 702 manages which flow has become a flow to be sampled by managing entries of flow identification information at the flow-to-be-sampled management table 704.

In step S906, the processing to manage a flow to be sampled is ended.

Further, as illustrated in FIG. 10, in step S1002, the capture determining unit 706 receives traffic data received at the switching unit 302 from the data identifying unit 306. According to reception of traffic data, a series of processing to capture traffic data belonging to a flow to be sampled is started.

Next, in step S1004, the capture determining unit 706 determines whether or not the received traffic data is data belonging to a flow included in an entry of the flow-to-be-sampled management table 704, with reference to each of the entries stored in the flow-to-be-sampled management table 704 in step S904. In the event that the received traffic data is data belonging to a flow included in an entry of the flow-to-be-sampled management table 704, the processing proceeds to step S1006, or otherwise, the processing proceeds to step S1010.

The capture determining unit 706 obtains flow identification information with reference to the MAC header, IP header, and TCP header included in the received traffic data, and compares the obtained flow identification information, and flow identification information stored in each of the entries of the flow-to-be-sampled management table 704, for example. The capture determining unit 706 determines, as a comparison result, in the event that both are in agreement, that the received traffic data is data of a flow managed at an entry of the flow-to-be-sampled management table 704, i.e., data belonging to a flow to be sampled.

In step S1006, the capture execution unit 708 captures the traffic data received in step S1002 in response to determination being made that the traffic data received in step S1004 is data belonging to a flow to be sampled. The capture execution unit 708 writes the captured traffic data in the capture memory 710.

Next, in step S1008, the capture transmission unit 712 reads out the written traffic data from the capture memory 710 in response to traffic data being newly written in the capture memory 710 in step S1006. The captured data transmission unit 712 transmits the read traffic data to the management device 208 via a network line for management as sampling data.

In step S1010, the processing to capture traffic data belonging to a flow to be sampled is ended.

### 1-5. Hardware Configuration of Servers 202 and Switch Devices 204

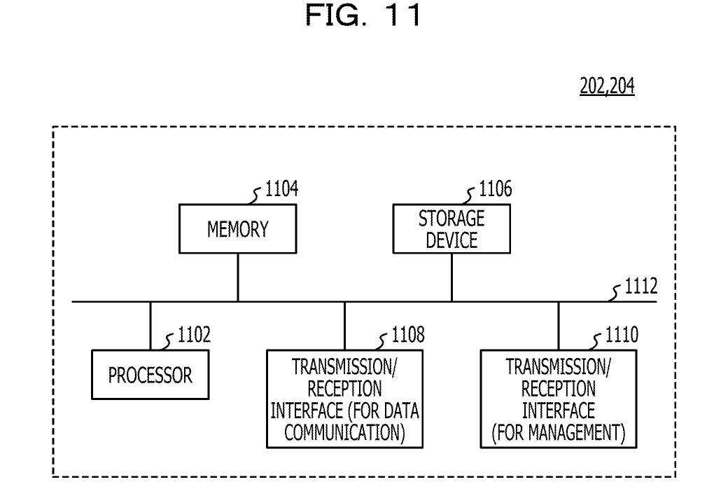

FIG. 11 is a hardware configuration diagram illustrating an internal configuration of the servers 202 and switch devices 204. FIG. 11 illustrates, in the same way as the function block diagram illustrated in FIG. 3, of the functions that the servers 202 and switch devices 204 have, a portion relating to the switching control function and flow sampling function of traffic data, and these functions are mutually similar at the servers 202 and switch devices 204. Accordingly, the servers 202 and switch devices 204 will collectively be described with reference to FIG. 11.

As illustrated in FIG. 11, the servers 202 and switch devices 204 include a processor 1102, memory 1104, a storage device 1106, a transmission/reception interface 1108 for data communication, a transmission/reception interface 1110 for management, and a bus 1112. The processor 1102, memory 1104, storage device 1106, and transmission/reception interfaces 1108 and 1110 are each coupled to the bus 1112.

The function of each function block of the servers 202 and switch devices 204 illustrated in FIGS. 3, 4, and 7 may be realized with the hardware configuration illustrated in FIG. 11. Here, the memory 1104 is RAM, for example. The storage device 1106 is nonvolatile memory such as ROM, flash memory, or the like, or a magnetic disk device such as an HDD (Hard Disk Drive) or the like, for example.

The function and processing of the data identifying unit 306 illustrated in FIG. 3 may be realized by the processor 1102 executing a processing program in which the corresponding function and processing is described.

The function and processing of the connection management unit 402, sampling deciding unit 406, and flow information setting unit 410 illustrated in FIG. 4 may be realized by the processor 1102 executing a processing program in which the corresponding function and processing is described.

The functions and processes of the flow-to-be-sampled management unit 702, capture determining unit 706, and capture execution unit 708 illustrated in FIG. 7 may be realized by the processor 1102 executing a processing program in which the corresponding function and processing is described.

The above-mentioned processing programs are stored in the storage device 1106, the processor 1102 loads a processing program stored in the storage device 1106 into the memory 1104, and executes the processes described in the processing program, thereby realizing the above-mentioned function blocks.

The connection management table 404 and sampling rate storage unit 408 illustrated in FIG. 4 are realized by the memory 1104 or storage device 1106. The flow-to-be-sampled management table 704 and capture memory 710 illustrated in FIG. 7 are similarly realized by the memory 1104 or storage device 1106. The processor 1102 performs desired access as to the memory 1104 or storage device 1106 based on the processes described in the above-mentioned processing programs, and accordingly, writing or readout of data as to the corresponding storage area is performed.

The function and processing of the switching unit 302 illustrated in FIG. 3 may be realized by the processor 1102 executing a processing program where the corresponding function and processing is described, and further controlling the transmission/reception interface 1108 capable of connecting to a network line for data communication. The transmission/reception interface 1108 is a widely-recognized I/O (Input/Output) circuit, for example.

The function and processing of the captured data transmission unit 712 illustrated in FIG. 7 may be realized by the processor 1102 executing a processing program where the corresponding function and processing is described, and further controlling the transmission/reception interface 1110 capable of connecting to a network line for management. The transmission/reception interface 1110 is a widely-recognized I/O (Input/Output) circuit, for example.

Note that the above-mentioned function blocks illustrated in FIGS. 3, 4, and 7 may be realized with an LSI such as an ASIC (Application Specified Integrated Circuit), FPGA (Field Programmable Gate Array) or the like in addition to the hardware configuration illustrated in FIG. 11.

### 2. Second Embodiment

Hereafter, description will be made regarding a node apparatus and a network system, according to a second embodiment.

### 2-1. Configuration of Data Center Network System 1200

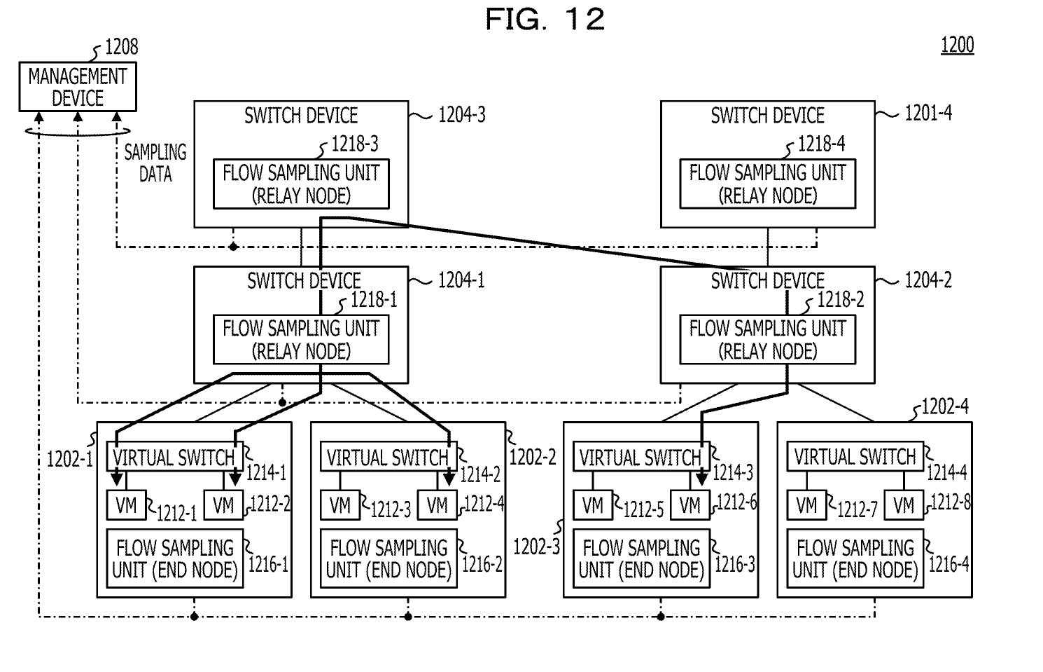

FIG. 12 is a diagram illustrating a configuration of a data center network system 1200 according to the second embodiment.

As illustrated in FIG. 12, the data center network system 1200 includes multiple node apparatuses including servers 1202-1 to 12002-4, switch devices 1204-1 to 1204-4, and a management device 1208. The servers 1202-1 to 1202-4 and switch devices 1204-1 to 1204-4 are coupled via a network line for data communication illustrated in a solid line in FIG. 12.

Each of the servers 1202-1 to 1202-4 includes at least one virtual switch and multiple virtual machines (VMs). For example, the server 1202-1 includes one virtual switch 1214-1 and two VMs 1212-1 and 1212-2. Each of the VMs 1212-1 and 1212-2 is coupled to the corresponding switch device 1204-1 via the virtual switch 1214-1. With the servers 1202-2 to 1202-4 as well, in the same way as with the server 1202-1, the multiple virtual machines 1212-3 to 1212-8 are coupled to the corresponding switch device 1204-1/1204-2 via the corresponding virtual switch of the virtual switches 1214-2 to 1214-4.

The switch devices 1204-1 to 1204-4 are physical switches serving as network repeaters, and are layer 2 switches (L2 switches). Each of the switch devices 1204-1 to 1204-4 includes a forwarding information table in which forwarding information of traffic data is stored. The switch devices 1204-1 to 1204-4 perform widely-recognized switching control to receive traffic data from a server or another switch device, and to decide a transfer path of the received traffic data with reference to the forwarding information table based on the communication protocol of the layer 2 (data link layer).

The virtual switches 1214-1 to 1214-4 are virtually provided network repeaters to be realized by a processor at the corresponding server executing a given program, and are layer 2 (L2) switches. Each of the virtual switches 1214-1 to 1214-4 includes, in the same way as with the switch devices 1204-1 to 1204-4, a forwarding information table in which forwarding information of traffic data is stored. The virtual switches 1214-1 to 1214-4 perform switching control to receive traffic data from a VM or switch device, and to decide a transfer path of the received traffic data with reference to the forwarding information table based on the communication protocol of the layer 2 (data link layer).

Each of the VMs 1212-1 to 1212-8 establishes connection with another VM, and performs communication of traffic data with the VM with which the connection has been established. In the event that connection has been established between two VMs, a communication path to pass through the corresponding virtual switch of the virtual switches 1214-1 to 1214-4 and at least one of the switch devices 1204-1 to 1204-4 is established between the two VMs thereof. Each communication path is established as a result of the above-mentioned switching control being executed at each of the switch devices and virtual switches positioned on the communication path thereof.

Traffic data belonging to the corresponding flow is transferred between the two VMs thereof using the established communication path.

With the example illustrated in FIG. 12, connection is established between the VM 1212-1 and VM 1212-4, and a communication path passing through the virtual switch 1214-1, switch device 1204-1, and virtual switch 1214-2 is established between the VM 1212-1 and VM 1212-4 as illustrated with a heavy solid line. Traffic data belonging to the corresponding flow is transferred between the VM 1212-1 and VM 1212-4 using the established communication path.

Also, connection is established between the VM 1212-2 and VM 1212-6, and a communication path passing through the virtual switch 1214-1, switch devices 1204-1, 1204-3, and 1204-2, and virtual switch 1214-3 is established between the VM 1212-2 and VM 1212-6 as illustrated with a heavy solid line. Traffic data belonging to a flow different from the flow between the VM 1212-1 and VM 1212-4 is transferred between the VM 1212-2 and VM 1212-6 using the established communication path.

Further, with the data center network system 1200, the servers 1202-1 to 1202-4 include flow sampling units 1216-1 to 1216-4, respectively. The switch devices 1204-1 to 1204-4 include flow sampling units 1218-1 to 1218-4, respectively.

The flow sampling units 1216-1 to 1216-4 are provided to end nodes of the data center network system 1200. The flow sampling units 1216-1 to 1216-4 receive traffic data generated by the corresponding two VMs of the VMs 1212-1 to 1212-8, and stochastically decide whether or not a flow to which the received traffic data belongs is to be taken as a flow to be sampled, based on flow control data included in the received traffic data. The flow sampling units 1216-1 to 1216-4 capture all of the traffic data belonging to the flow decided to be sampled (flow to be sampled), and output the captured traffic data to the management device 1208 as sampling data.

Further, the flow sampling units 1216-1 to 1216-4 instruct the virtual switches 1214-1 to 1214-4 so as to add marking information indicating that this traffic data belongs to a flow to be sampled, to all of the traffic data belonging to a flow to be sampled, respectively.

The virtual switches 1214-1 to 1214-4 add given marking information to all of the traffic data belonging to a flow to be sampled, based on the instructions from the flow sampling units 1216-1 to 1216-4, respectively. The marking information is stored in a given field of traffic data. The virtual switches 1214-1 to 1214-4 transmit traffic data to which the marking information is added, to the corresponding switch device 1204-1/1204-2.

Details regarding the flow sampling units 1216-1 to 1216-4, virtual switches 1214-1 to 1214-4, flow control data, and marking information will be described later.

The flow sampling units 1218-1 to 1218-4 receive traffic data from the servers 1202-1 to 1202-4 or switch devices 1204-1 to 1204-4 other than the own device, and determine whether or not the received traffic data is data belonging to a flow to be sampled, based on marking information included in the received traffic data. The flow sampling units 1218-1 to 1218-4 capture all of the traffic data determined to belong to a flow to be sampled, and output the captured traffic data to the management device 1208 as sampling data.

For example, the flow sampling units 1218-1 to 1218-4 capture traffic data belonging to the same flow to be sampled based on marking information added by the flow sampling unit 1216 of the transmission source server 1202, and transmit the captured traffic data to the management device 1208 as sampling data.

Details regarding the flow sampling units 1218-1 to 1218-4 and marking information will be described later.

The management device 1208 is coupled to the servers 1202-1 to 1202-4 and switch devices 1204-1 to 1204-4 via a network line for management illustrated in a dashed-dotted line in FIG. 12. The network lines for management illustrated in a dashed-dotted line are lines separated from the network lines for data communication illustrated in a solid line. The management device 1208 receive sampling data from each of the servers 1202-1 to 1202-4 and switch devices 1204-1 to 1204-4 via a network line for management.

The management device 1208 performs analysis of the header and payload of the received sampling data, thereby executing flow property analysis regarding a flow to be sampled. Examples of the flow property analysis include analysis of a parameter regarding performance of the flow thereof, a flow rate of traffic data belonging to the flow thereof, analysis regarding a loss rate and the number of times of retransmissions, and sequence analysis of TCP regarding traffic data belonging to the flow thereof.

The management device 1208 continues reception of sampling data from the servers 1202-1 to 1202-4 and switch devices 1204-1 to 1204-4 while the data center network system 1200 is activated. The management device 1208 continuously receives sampling data from each of the servers or switch devices during an activation period of the data center network system 1200 in a periodical manner, thereby accumulating the sampling data from each of the servers or switch devices.

The management device 1208 performs statistical processing on the property analysis results of the flow to be sampled based on each of stored sampling data, thereby obtaining statistical information indicating a traffic tendency on a per-flow basis regarding the data center network system 1200.

Further, each of the node apparatuses transmits sampling data belonging to the same flow to be sampled based on the marking information, and accordingly, the management device 1208 obtains, regarding one traffic data belonging to a flow to be sampled, sampling data corresponding to the same traffic data from each of the node apparatuses positioned on a communication path through which the one traffic data thereof passes.

Thus, the management device 1208 focuses on one traffic data, and executes flow property analysis in a node-cross-sectional manner while tracing the focused traffic data at each of the node apparatuses positioned on the communication path thereof. Details of processing to be performed at the management device 1208 will be described later.

As described above, with the network system 1200 according to the second embodiment, the servers 1202 and switch devices 1204 making up the network system capture all of the traffic data belonging to a flow to be sampled on a per-flow basis, and transmit the captured traffic data to the management device 1208 as sampling data, and accordingly, the management device 1208 may execute traffic property analysis on a per-flow basis based on a series of sampling data belonging to one flow, and obtain analysis results of parameters regarding flow performance (flow rate, loss rate, number of times of retransmissions, and so forth of the flow). Further, the management apparatus 1208 may estimate a traffic tendency of the entire data center network system 1200 using statistical processing of the analysis results thereof as a traffic tendency on a per-flow basis.

Further, based on the marking information added by the transmission source server 1202, all of the node apparatuses positioned on the communication path of a flow decided to be sampled by the transmission source server 1202 select the same flow as a flow to be sampled, and accordingly, the management device 1208 may execute flow property analysis in a node-cross-sectional manner while tracing the focused one traffic data at each of the node apparatuses positioned on the communication path thereof. Thus, the management device 1208 may perform analyses such as transition time between node apparatuses, transfer delay time at each of the node apparatuses, and so forth regarding one traffic data.

Note that, with the data center network system 1200 illustrated in FIG. 12, the flows sampling units 1216-1 to 1216-4 and 1218-1 to 1218-4 are provided to the servers 1202-1 to 1202-4 and switch devices 1204-1 to 1204-4 making up the system respectively, but the present technology is not restricted to this configuration. The flow sampling unit may be provided to some devices selected out of the servers 202-1 to 202-4 and switch devices 204-1 to 204-4, e.g., with regard to the switch devices 1204-1 to 1204-4, the flow sampling unit may be selectively provided to some switch devices.

### 2-2. Internal Configuration of Servers 1202

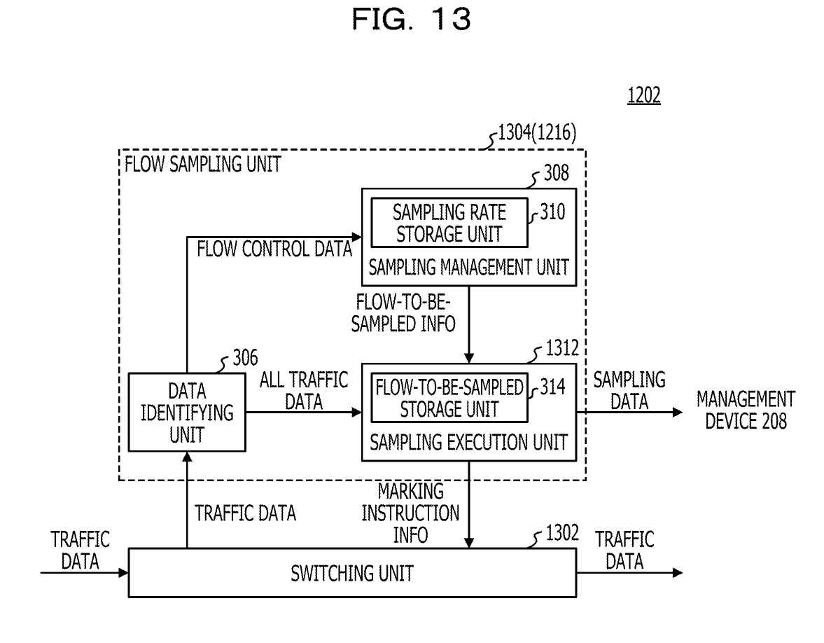

FIG. 13 is a function block diagram illustrating an internal configuration of the servers 1202. FIG. 13 illustrates portions relating to the switching control function and flow sampling function of traffic data of the functions that the servers 1202 have.

The servers 1202 illustrated in FIG. 13 differ from the servers 202 illustrated in FIG. 3 in that a switching unit 1302, a flow sampling unit 1304, and a sampling execution unit 1312 are provided instead of the switching unit 302, flow sampling unit 304, and sampling execution unit 312, but portions other than these are similar to the corresponding portions of the servers 202 illustrated in FIG. 3. The same portions as or the portions corresponding to portions of the servers 202 illustrated in FIG. 3 are denoted with the same reference numerals. The operation and function of portions denoted with the same reference numerals in FIG. 13 are as described in association with FIG. 3, and accordingly, detailed description will be omitted.

As illustrated in FIG. 13, the servers 1202 include the switching unit 1302 and flow sampling unit 304, and the flow sampling unit 1304 includes the sampling execution unit 1312. The flow sampling unit 1304 corresponds to the flow sampling unit 1216 illustrated in FIG. 12.

The sampling execution unit 1312 includes the flow-to-be-sampled storage unit 314, and receives flow-to-be-sampled information from the sampling management unit 308. The sampling execution unit 1312 stores flow identification information included in the received flow-to-be-sampled information in the flow-to-be-sampled storage unit 314.

The sampling execution unit 1312 receives all of the traffic data received at the switching unit 1302 from the data identifying unit 306. The sampling execution unit 1312 determines whether or not each of the received traffic data is data belonging to a flow to be sampled, with reference to flow identification information regarding a flow to be sampled, stored in the flow-to-be-sampled storage unit 314.

The sampling execution unit 1312 obtains flow identification information regarding a flow to which the received traffic data belongs with reference to the MAC header, IP header, and TCP header included in the received traffic data. The sampling execution unit 1312 compares the obtained flow identification information and flow identification information regarding a flow to be sampled, stored in the flow-to-be-sampled storage unit 314, and in the event that both are in agreement, determines that the received traffic data is data belonging to a flow to be sampled.

The sampling execution unit 1312 captures, in the event of having determined that the received traffic data is data belonging to a flow to be sampled, the traffic data thereof. The sampling execution unit 1312 outputs the captured traffic data to the management device 208 illustrated in FIG. 2 via a network line for management, as sampling data.

Further, the sampling execution unit 1312 generates marking instruction information in the event of having determined that the received traffic data is data belonging to a flow to be sampled. The marking instruction information is instruction information to instruct to add marking information to traffic data, and the marking information is identification information indicating that the traffic data thereof is data belonging to a flow to be sampled. The sampling execution unit 1312 outputs the generated marking instruction information to the switching unit 1302. Details regarding the sampling execution unit 1312 will be described later.

The switching unit 1302 receives traffic data from another switch device 1204 or a VM 1212 provided to the inner portion of a server 1202, and internally holds the received traffic data. The switching unit 1302 outputs all of the received traffic data to the data identifying unit 306 within the flow sampling unit 1304.

The switching unit 1302 includes a forwarding information table (not illustrated) in which forwarding information of traffic data is stored. The switching unit 1302 performs widely-recognized switching control to decide a transfer path of internally held traffic data based on the communication protocol of the layer 2 (data link layer) with reference to the forwarding information table. The switching unit 1302 corresponds to the virtual switches 1214 provided to the inner portions of the servers 1202.

Further, the switching unit 1302 receives marking instruction information from the sampling execution unit 1312. The switching unit 1302 adds given marking information to traffic data internally held at the time of receiving marking instruction information from the sampling execution unit 1312. The marking information is stored in a given field of traffic data.

Accordingly, in the event that the received traffic data is data belonging to a flow to be sampled, the switching unit 1302 may output traffic data to which marking information has been added, to the switch device 204 decided by switching control. That is to say, the switching unit 1302 serves as a marking unit configured to add marking information to traffic data belonging to a flow to be sampled.

On the other hand, in the event that the received traffic data is data belonging to a flow to be sampled, the switching unit 1302 outputs the traffic data thereof to the switch device 204 decided by switching control without changing the traffic data thereof.

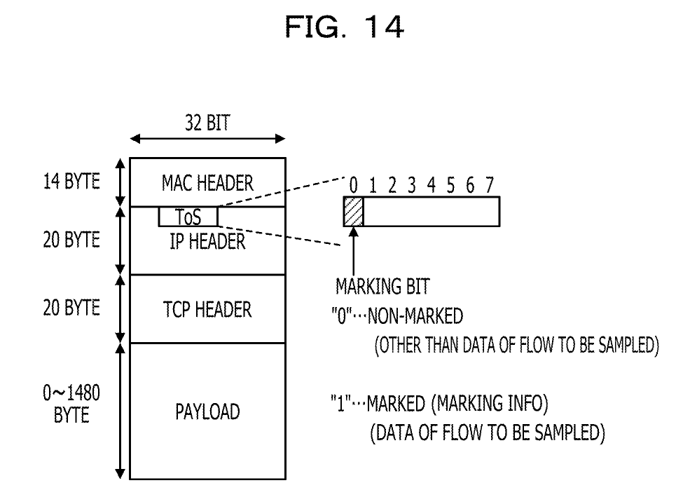

FIG. 14 is a diagram indicating an example of marking information to be added to traffic data. As indicated in FIG. 14, traffic data which flows into the data center network system 1200 includes the payload, TCP header, IP header, and MAC header.

With the example indicated in FIG. 14, marking information is stored in a ToS (Type of Service) field included in the IP header, e.g., out of eight bits from bit “0” to bit “7” making up the ToS field, marking information is stored in the bit “0”.

With the servers and switch devices making up the data center network system 1200, for example, a rule is negotiated beforehand wherein when information “1” is stored in the bit “0” of the ToS field, this indicates that the traffic data thereof is data belonging to a flow to be sampled, and when information “0” is stored in the bit “0” of the ToS field, this indicates that the traffic data thereof is not data belonging to a flow to be sampled. In this case, information “1” to be stored in the bit “0” of the ToS field becomes marking information.

Thus, with the data center network system 1200, the servers and switch devices may recognize whether or not the received traffic data is data belonging to a flow to be sampled with reference to marking information included in the traffic data thereof.

As described above, with the servers 1202 according to the second embodiment, the switching unit 1302 adds marking information to traffic data belonging to a flow to be sampled, based on marking instruction information output from the sampling execution unit 1312, and accordingly, when the own device is the transmission source server, it may be informed to another server 1202 or switch device 1204 positioned on a communication path of a flow to be sampled that the traffic data to be transmitted is data belonging to a flow to be sampled.

Note that the hardware configuration of the servers 1202 is similar to the hardware configuration of the servers 202 illustrated in FIG. 11. The function of each function block of the servers 1202 may be realized with the same hardware configuration as with the hardware configuration of the servers 202 illustrated in FIG. 11. Accordingly, detailed description thereof will be omitted.

### 2-3. Sampling Execution Unit 1312

### 2-3-1. Configuration of Sampling Execution Unit 1312

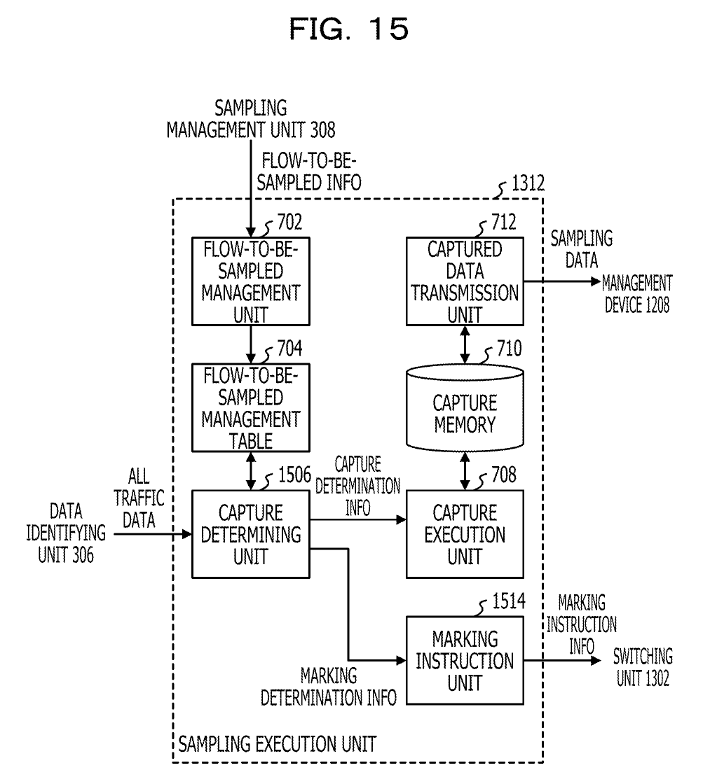

FIG. 15 is a function block diagram illustrating a configuration of the sampling execution unit 1312 included in the flow sampling units 1304 of the servers 1202.

With the sampling execution unit 1312 illustrated in FIG. 15 differs from the sampling execution unit 312 illustrated in FIG. 7 in that a capture determining unit 1506 is provided instead of the capture determination unit 706, and a marking instruction unit 1514 is added, but portions other than these are similar to the corresponding portions of the sampling execution unit 312 illustrated in FIG. 7. The same portions as or the portions corresponding to portions of the sampling execution unit 312 illustrated in FIG. 7 are denoted with the same reference numerals. The operation and function of portions denoted with the same reference numerals in FIG. 15 are as described in association with FIG. 7, and accordingly, detailed description will be omitted.

In FIG. 15, the capture determining unit 1506 receives all of the received traffic data at the switching unit 1302 from the data identifying unit 306. The capture determining unit 1506 determines whether or not each of the received traffic data is data belonging to a flow to be sampled with reference to each of the entries stored in the flow-to-be-sampled management table 704, based on the received traffic data.

The capture determining unit 1506 obtains flow identification information of a flow to which the received traffic data belongs with reference to the MAC header, IP header, and TCP header included in the received traffic data. The capture determining unit 1506 compares the obtained flow identification information and flow identification information stored in each of the entries in the flow-to-be-sampled management table 704. The capture determining unit 1506 determines, as a comparison result, in the event that both are in agreement, that the received traffic data is data belonging to a flow to be sampled.

The capture determining unit 1506 determines, in the event that the received traffic data is data belonging to a flow to be sampled, that the traffic data thereof is data to be captured, and generates capture determination information. The capture determination information indicates that the traffic data thereof is data to be captured. The capture determining unit 1506 outputs the generated capture determination information and the corresponding traffic data to the capture execution unit 708.

Further, in the event that the received traffic data is data belonging to a flow to be sampled, the capture determining unit 1506 determines that the received traffic data is data to which marking information has to be added, and generates marking determination information. The marking information is identification information indicating that the traffic data thereof is data belonging to a flow to be sampled, and the marking determination information is determination information indicating that the received traffic data is data to which the above-mentioned marking information has to be added. The capture determining unit 1506 outputs the generated marking determination information to the marking instruction unit 1514.

The marking instruction unit 1514 receives the marking determination information from the capture determining unit 1506. The marking instruction unit 1514 generates marking instruction information based on the received marking determination information. The marking instruction information is instruction information to instruct to add the above-mentioned marking information to traffic data. The marking instruction unit 1514 outputs the generated marking instruction information to the switching unit 1302.

As described above, with the sampling execution unit 1312 according to the second embodiment, the capture determining unit 1506 suitably filters traffic data alone belonging to a flow to be sampled, out of all of the traffic data, and accordingly, the marking instruction unit 1514 suitably informs information of traffic data belonging to a flow to be sampled to which marking information has to be added, to the switching unit 1302.

### 2-3-2. Traffic Data Sampling Execution Method

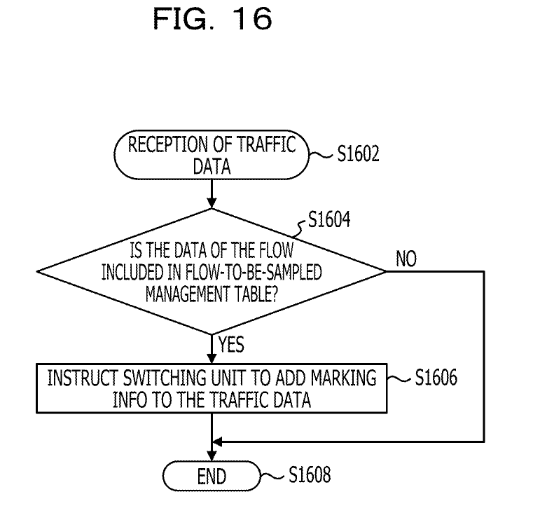

FIG. 16 is a flowchart illustrating a sampling execution method of traffic data belonging to a flow to be sampled, to be executed at the sampling execution unit 1312, and is a flowchart illustrating a marking instruction method as to traffic data belonging to a flow to be sampled, at the sampling execution unit 1312.

Note that the sampling execution unit 1312 illustrated in FIG. 15 executes, in the same way as with the sampling execution unit 312 illustrated in FIG. 7, with a sampling execution method, a management method of a flow to be sampled illustrated in the flowchart in FIG. 9, and a capture method of traffic data belonging to a flow to be sampled illustrated in the flowchart in FIG. 10, but each of the methods is as described in FIGS. 9 and 10, and accordingly, detailed description will be omitted.

Hereafter, description will be made regarding a marking instruction method to be executed at the sampling execution unit 1312, with reference to FIG. 15 in addition to FIG. 16.

As illustrated in FIG. 16, in step S1602, the capture determining unit 1506 receives traffic data received at the switching unit 1302 from the data identifying unit 306. According to reception of traffic data, a series of processing to instruct marking on traffic data belonging to a flow to be sampled is started.

Next, in step S1604, the capture determining unit 1506 determines whether or not the received traffic data is data belonging to a flow included in an entry of the flow-to-be-sampled management table 704, with reference to each of the entries stored in the flow-to-be-sampled management table 704. In the event that the received traffic data is data belonging to a flow included in an entry of the flow-to-be-sampled management table 704, the processing proceeds to step S1606, or otherwise, the processing proceeds to step S1608.

The capture determining unit 1506 obtains flow identification information, for example, with reference to the MAC header, IP header, and TCP header included in the received traffic data, and compares the obtained flow identification information, and flow identification information stored in each of the entries of the flow-to-be-sampled management table 704. The capture determining unit 706 determines, as a comparison result, in the event that both are in agreement, that the received traffic data is data of a flow managed at an entry of the flow-to-be-sampled management table 704, i.e., data belonging to a flow to be sampled.

In step S1606, the marking instruction unit 1514 instructs, in response to determination being made that the traffic data received in step S1602 is data belonging to a flow to be sampled, the switching unit 1302 to add marking information to the traffic data received in step S1602. The marking information is identification information indicating that the traffic data thereof is data belonging to a flow to be sampled.

In step S1608, the processing to instruct marking as to traffic data belonging to a flow to be sampled is ended.

### 2-4. Internal Configuration of Switch Devices 1204

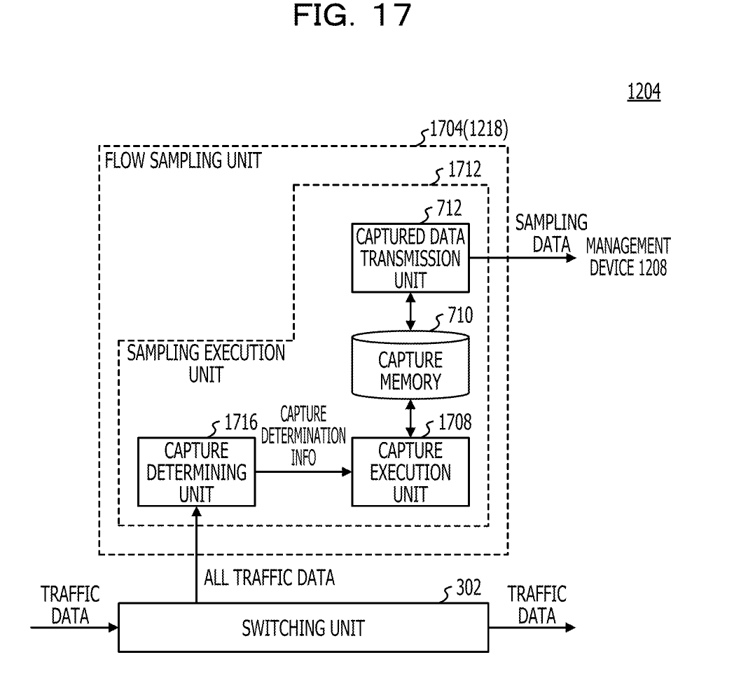

FIG. 17 is a function block diagram illustrating an internal configuration of the switch devices 1204. FIG. 17 illustrates, of the functions that the switch devices 1204 has, portions relating to the switching control function and flow sampling function of traffic data.

The switch devices 1204 illustrated in FIG. 17 differ from the switch devices 204 illustrated in FIG. 3 in that a flow sampling unit 1704 is provided instead of the flow sampling unit 304, but portions other than this are similar to the corresponding portions of the switch devices 204 illustrated in FIG. 3.

Also, the flow sampling unit 1704 illustrated in FIG. 17 differs from the flow sampling unit 304 illustrated in FIG. 3 in that the data identifying unit 306 and sampling management unit 308 are not provided, and a sampling execution unit 1712 is provided instead of the sampling execution unit 312. The flow sampling unit 1704 corresponds to the flow sampling unit 1218 illustrated in FIG. 12.

The same portions as or portions corresponding to portions of the switch devices 204 and flow sampling unit 304 in FIG. 3 are denoted with the same reference numerals. The operation and function of portions denoted with the same reference numerals in FIG. 17 are as described in association with FIG. 3, and accordingly, detailed description will be omitted.

Note that the hardware configuration of the switch devices 1204 is similar to the hardware configuration of the switch devices 204 illustrated in FIG. 11. The function of each function block of the switch devices 1204 may be realized with the similar hardware configuration as the hardware configuration of the switch devices 204 illustrated in FIG. 11, and accordingly, detailed description will be omitted.

### 2-4-1. Configuration of Sampling Execution Unit 1712

The sampling execution unit 1712 illustrated in FIG. 17 differs from the sampling execution unit 312 illustrated in FIG. 7 in that the flow-to-be-sampled management unit 702 and flow-to-be-sampled management table 704 are not provided, and a capture determining unit 1716 and a capture execution unit 1708 are provided instead of the capture determining unit 706 and capture execution unit 708, but portions other than these are similar to the corresponding portions of the sampling execution unit 312 illustrated in FIG. 7. The same portions as or the portions corresponding to portions of the sampling execution unit 312 illustrated in FIG. 7 are denoted with the same reference numerals. The operation and function of portions denoted with the same reference numerals in FIG. 17 are as described in association with FIG. 7, and accordingly, detailed description will be omitted.

As illustrated in FIG. 17, the capture determining unit 1716 receives all of the traffic data received at the switching unit 302 from the switching unit 302. The capture determining unit 1716 determines whether or not marking information has been added to the received traffic data, thereby determining whether or not each of the received traffic data is data belonging to a flow to be sampled. The capture determining unit 1716 checks whether or not marking information is stored in a given field of the received traffic data, thereby determining whether or not the received traffic data is data belonging to a flow to be sampled.

The capture determining unit 1716 checks, as illustrated in FIG. 14, whether or not information “1” is stored in the bit “0” of the ToS field as marking information with reference to the ToS filed included in the IP header of the received traffic data, for example. In the event that information “1” (marking information) is stored in the bit “0” of the ToS field, the capture determining unit 1716 determines that the received traffic data is data belonging to a flow to be sampled.

In the event that the received traffic data is data belonging to a flow to be sampled, the capture determining unit 1716 determines that the traffic data thereof is data to be captured, and generates capture determination information. The capture determination information indicates that the traffic data thereof is data to be captured. The capture determining unit 1716 outputs the generated capture determination information and the corresponding traffic data to the capture execution unit 708.

The capture execution unit 1708 receives the capture determination information and the corresponding traffic data from the capture determining unit 1716. The capture execution unit 1708 captures, in response to the capture determination information, the received traffic data, and writes the captured traffic data in the capture memory 710.

As described above, with the sampling execution unit 1712 according to the second embodiment, the capture determining unit 1716 suitably filters traffic data alone belonging to a flow to be sampled, out of all of the traffic data, and accordingly, the capture execution unit 708 may capture traffic data alone belonging to a flow to be sampled, on a per-flow basis, and transmit the captured traffic data to the management device 1208 as sampling data.

Further, the capture determining unit 1716 suitably filters traffic data belonging to a flow to be sampled based on the marking information added by the transmission source server 1202, and accordingly, the same flow as with another node apparatus positioned on the communication path of the flow decided to be a flow to be sampled by the transmission source server 1202 may be selected as a flow to be sampled.

Thus, the management device 1208 may execute flow property analysis in a node-cross-sectional manner while tracing the focused one traffic data at each of the node apparatuses positioned on the communication path thereof.

### 2-4-2. Traffic Data Sampling Execution Method

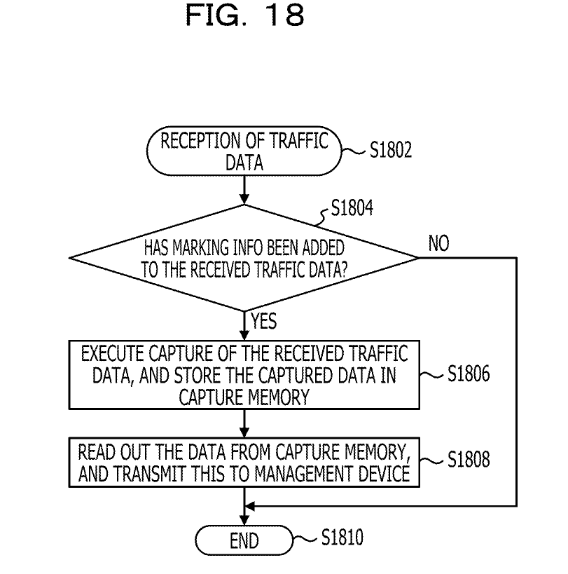

FIG. 18 is a flowchart illustrating a sampling execution method of traffic data belonging to a flow to be sampled, and is a flowchart illustrating a capture method of traffic data belonging to a flow to be sampled, executed at the sampling execution unit 1712. Hereafter, description will be made regarding a capture method of traffic data, to be executed at the sampling execution unit 1712 with reference to FIG. 17 in addition to FIG. 18.

As illustrated in FIG. 18, in step S1802, the capture determining unit 1716 receives traffic data received at the switching unit 1302, from the switching unit 302. According to reception of traffic data, a series of processing to capture traffic data belonging to a flow to be sampled is started.

Next, in step S1804, the capture determining unit 1716 checks whether or not marking information is stored in a given field of the received traffic data, thereby determining whether or not marking information has been added to the received traffic data. In the event that marking information has been added to the received traffic data, the processing proceeds to step S1806, or otherwise, the processing proceeds to step S1810.

The capture determining unit 1716 checks whether or not information “1” is stored in the bit “0” of the ToS field included in the IP header of the received traffic data as marking information, for example. In the event that information “1” (marking information) is stored in the bit “0” of the ToS field, the capture determining unit 1716 determines that marking information has been added to the received traffic data, and the traffic data thereof is data belonging to a flow to be sampled.

In step S1806, the capture execution unit 1708 captures the traffic data received in step S1802 in response to that marking information has been added to the traffic data received in step S1802. The capture execution unit 1708 writes the captured traffic data in the capture memory 710.

Next, in step S1808, the captured data transmission unit 712 reads out, in response to that the traffic data has been newly written in the capture memory 710 in step S1806, the written traffic data from the capture memory 710. The captured data transmission unit 712 transmits the read traffic data to the management device 1208 via a network line for management, as sampling data.

In step S1810, the processing to capture traffic data belonging to a flow to be sampled is ended.

### 3. Processing at Management Device

Next, description will be made regarding processing to be executed by the management device 208 according to the first embodiment and the management device 1208 according to the second embodiment.

As described above, the management device 208 continues reception of sampling data from the node apparatuses making up the data center network system 200, for example, the servers 202-1 to 202-4 and switch devices 204-1 to 204-4 in a periodical manner while the data center network system 200 is activated, thereby accumulating the sampling data from each of the servers or switch devices.

The management device 208 performs, based on the accumulated individual sampling data, property analysis of a flow to be sampled, and also performs statistical processing on the property analysis results thereof, thereby obtaining statistical information indicating a traffic tendency on a per-flow basis regarding the data center network system 200.

Similarly, the management device 1208 continues reception of sampling data from the node apparatuses making up the data center network system 1200, for example, the servers 1202-1 to 1202-4 and switch devices 1204-1 to 1204-4 in a periodical manner while the data center network system 1200 is activated, thereby accumulating the sampling data from each of the servers or switch devices.

The management device 1208 performs, based on the accumulated individual sampling data, property analysis of a flow to be sampled, and also performs statistical processing on the property analysis results thereof, thereby obtaining statistical information indicating a traffic tendency on a per-flow basis regarding the data center network system 1200.

The management devices 202 and 1208 execute the following processing based on the statistical information indicating a traffic tendency on a per-flow basis obtained as described above.

### 3-1. Visualization of Information on Per-flow Basis

The management devices 208 and 1208 generate status information where path information of each flow, and statistical information regarding the performance of each flow (the flow rate, loss rate, and the number of timed of retransmissions of the flow) are displayed together on a map illustrating connection relations of the node apparatuses in the data center network based on the obtained statistical information indicating a traffic tendency on a per-flow basis, map information of the corresponding data center network (connection information of node apparatuses), and path information of each flow. The management devices 208 and 1208 display the generated status information on a display device (not illustrated) such as a display or the like provided to the own device.

A network administrator may recognize how much flow rate of traffic data flows into which communication path corresponding to which flow, with reference to the status information displayed on the above-mentioned display device.

Thus, the network administrator may change the communication path of each flow, or change the locations of VMs generated in each server so as to reduce bias of traffic data that flows into the node apparatuses on the network to even the usage rates of the bands of multiple transfer paths at the node apparatuses.

Note that the management devices 208 and 1208 may transmit the generated status information to an information terminal (personal computer, smart phone, or the like) of the network administrator instead of the generated status information being displayed on the display device such as a display or the like.

### 3-2. Application of Provisioning

As described above, the network administrator may obtain the status information such how much flow rate of traffic data flows into which communication path corresponding to which flow, using the management devices 208 and 1208. The network administrator may derive information such that the band of a particular transfer path comes close to a saturation state at a particular node apparatus positioned on the communication path of a particular flow, based on the obtained status information.

Thus, the network administrator may use provisioning to request a network user who uses the corresponding node apparatus to perform extension of the band of the transfer path of the node apparatus, or to prompt the network user to perform facility expansion of the node apparatus.

### 3-3. Switching of Communication Path

The management devices 208 and 1208 monitor in full time, of statistical information indicating a traffic tendency on a per-flow basis, parameters regarding the performance of each flow, such as a flow rate, loss rate, the number of times of retransmission of a flow, and so forth. These parameters are parameters relating to a congestion and a failure on the network. Thus, the management devices 208 and 1208 may detect that a congestion or failure has occurred at a particular flow in the corresponding data center network systems 202 and 1202, respectively.

The management devices 208 and 1208 judge, when the values of the parameters such as the flow rate, loss rate, and the number of times of retransmissions of a flow exceed given values, that a congestion or failure has occurred at the corresponding flow, for example. The management devices 208 and 1208 further estimate a node apparatus where a congestion or failure has occurred, with reference to an overlapped situation between the communication path of a flow where occurrence of a congestion or failure has been detected, and the communication path of another flow, and the parameters and so forth regarding the performance of another flow.

The management devices 208 and 1208 change the communication path of the corresponding flow so as to bypass the node apparatus estimated such that a congestion or failure has occurred, for example.

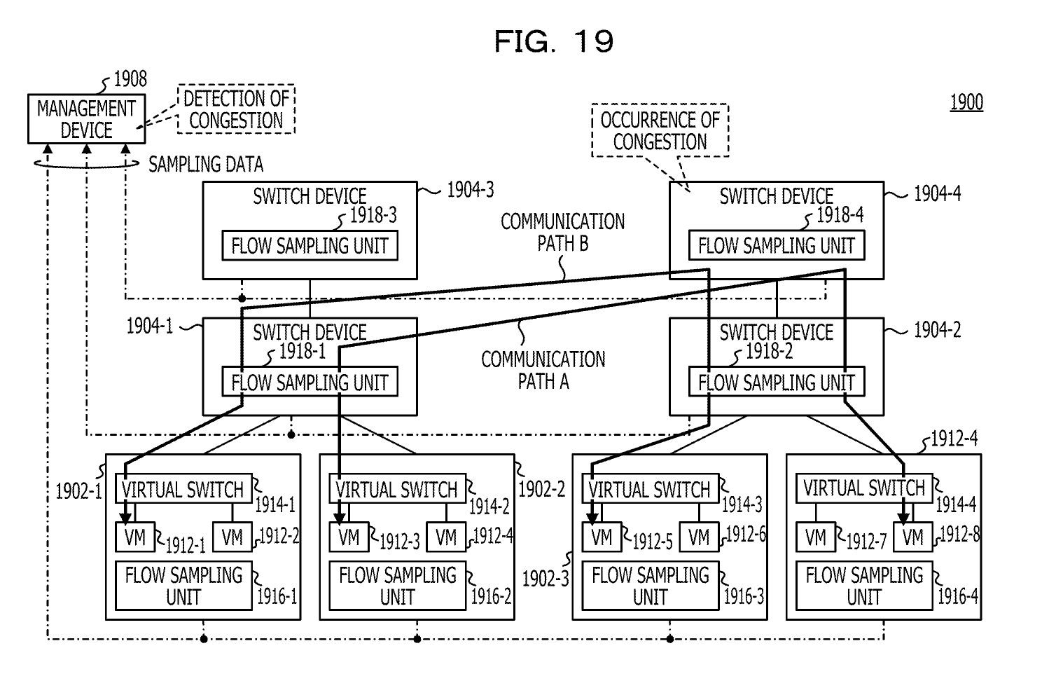

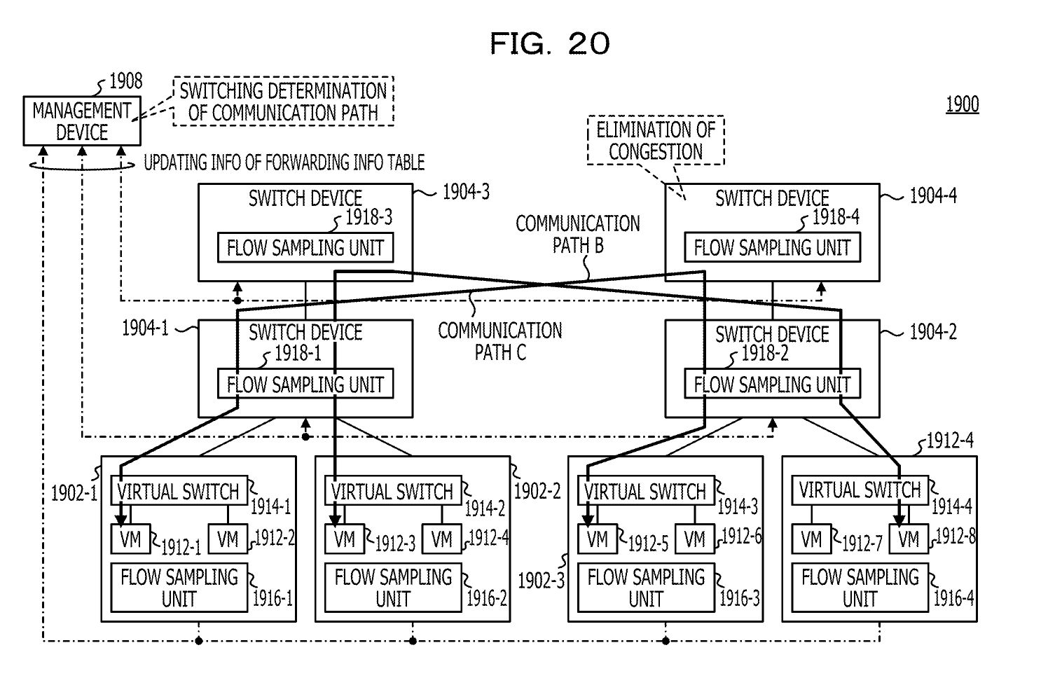

FIGS. 19 and 20 are diagrams for describing communication path switching processing in a case where a congestion has occurred in a data center network system 1900.

As illustrated in FIG. 19, the data center network 1900 includes servers 1902-1 to 1902-4, switch devices 1904-1 to 1904-4, and a management device 1908.

The servers 1902-1 to 1902-4 include virtual switches 1914-1 to 1914-4, the corresponding two VMs of VMs 1912-1 to 1912-8, and flow sampling units 1916-1 to 1916-4, respectively. The flow sampling units 1916-1 to 1916-4 correspond to the flow sampling unit 304 illustrated in FIG. 3 or the flow sampling unit 1304 illustrated in FIG. 13.

The switch devices 1904-1 to 1904-4 include flow sampling units 1918-1 to 1918-4, respectively. The flow sampling units 1918-1 to 1918-4 correspond to the flow sampling unit 304 illustrated in FIG. 3 or the flow sampling unit 1704 illustrated in FIG. 17.

With the example illustrated in FIG. 19, in the data center network system 1900, a communication path A passed through the virtual switch 1914-2, switch devices 1904-1, 1904-4, and 1904-2, and virtual switch 1914-4 has been established between the VMs 1912-3 and 1912-8 as illustrated in a heavy solid line. Also, a communication path B passed through the virtual switch 1914-1, switch devices 1904-1, 1904-4, and 1904-2, and virtual switch 1914-3 has been established between the VMs 1912-1 and 1912-5 as illustrated in a heavy solid line.

The management device 1908 accumulates sampling data transmitted from each of the servers 1902 and switch devices 1904. The management device 1908 performs property analysis and statistical processing regarding the parameters such as the flow rate, loss rate, the number of times of retransmissions, and so forth of a flow to be sampled, based on the accumulated sampling data, thereby monitoring the parameters such as the flow rate, loss rate, the number of times of retransmissions, and so forth of a flow regarding the performance of the flow in full time, and determining that a congestion has occurred at the corresponding flow when the values of the parameters thereof exceed given thresholds.

With the example illustrated in FIG. 19, let us say that the management device 1908 has detected that a congestion has occurred at a flow corresponding to the communication path A.

At this time, the management device 1908 estimates a node apparatus where a congestion has occurred, out of node apparatuses positioned in the communication path A of the flow where a congestion has been detected, based on an overlapped situation between the communication path A of the flow where a congestion has been detected, and the communication path B of another flow, and the parameters regarding the performance of a flow corresponding to the communication path B (flow rate, loss rate, the number of times of retransmissions, and so forth of the flow).

With the example illustrated in FIG. 19, let us say that the management device 1908 has estimated that a congestion has occurred at the switch device 1904-4 where the communication path A and communication path B are overlapped.

At this time, the management device 1908 changes the communication path A of the flow where a congestion has been detected so as to bypass the switch device 1904-4 estimated that a congestion has occurred. The management device 1908 decides the communication path after change based on the parameters regarding the performance of a flow corresponding to the communication path B.

With the example illustrated in FIG. 19, let us say that the management device 1908 has decided to change the communication path A to a new communication path C illustrated in FIG. 20.

At this time, the management device 1908 instructs the switch devices 1904-1 to 1904-4 to update a forwarding information table corresponding to the flow where a congestion has been detected so as to establish the decided new communication path C. The management device 1908 generates, based on the decided new communication path C, updating information of the forwarding information table corresponding to the flow where a congestion has been detected, held in the switch devices 1904-1 to 1904-4. The management device 1908 transmits the generated updating information to the switch devices 1904-1 to 1904-4 via a network line for management.

With the example illustrated in FIG. 20, the management device 1908 updates, with regard to a flow where a congestion has been detected, the corresponding forwarding information table so as to change the communication path with the switch device 1904-4 to the communication path with the switch device 1904-3 at each of the switch devices 1904-1 and 1904-2. The management device 1908 updates, with regard to the flow where a congestion has been detected, the corresponding forwarding information table so as to newly establish a communication path between the switch devices 1904-1 and 1904-2 at the switch device 1904-3. The management device 1908 updates, with regard to the flow where a congestion has been detected, the corresponding forwarding information table so as to delete the communication path already established between the switch devices 1904-1 and 1904-2 at the switch device 1904-4.

### 3-4. Change of VM Location

The management devices 208 and 1208 monitor in full time, as described above, of the obtained statistical information indicating a traffic tendency on a per-flow basis, the parameters of the flow rate, loss rate, the number of times of retransmissions, and so forth of the flow regarding the performance of each flow.

The management devices 208 and 1208 determine, for example, when the parameters of the flow rate, loss rate, the number of times of retransmissions, and so forth of a flow exceed given thresholds, that a congestion or failure has occurred at the corresponding flow, and estimates a node apparatus where a congestion or failure has occurred, with reference to an overlapped situation between the communication path of the flow where a congestion or failure has been detected, and the communication path of another flow, and the parameters regarding the performance of another flow, and so forth.

The management devices 208 and 1208 change the location of a VM corresponding to a flow where a congestion or failure has been detected so as to bypass a node device estimated that a congestion or failure has occurred, for example.

With the example illustrated in FIG. 19, with regard to a flow corresponding to the communication path A, in the event that estimation is made that a congestion has occurred at the switch device 1904-4, the management devices 208 and 1208 move the VM 1912-8 corresponding to the communication path A positioned in the server 1902-4 to the server 1902-1 or 1902-2, for example.

At this time, the management devices 208 and 1208 instruct the movement source server 1902-4, and the movement destination server 1902-1 or 1902-2 to perform execution of live migration (Live Migration) of the VM 1912-8.

As described above, though description has been made regarding a node apparatus and a network system according to exemplified embodiments of the present technology, the present technology is not restricted to the specific disclosed embodiments, and various modifications and changes may be performed without departing from the scope of the technical idea laid forth in the Claims.

Also, the techniques disclosed in the embodiments may be combined as appropriate as long as the techniques are not mutually conflicted.

According to the present embodiment, with a network system such as a large-scale data center network as well, the property analysis of traffic which flows into the network thereof is performed in increments of flows to which traffic data belongs.

All examples and conditional language recited herein are intended for pedagogical purposes to aid the reader in understanding the invention and the concepts contributed by the inventor to furthering the art, and are to be construed as being without limitation to such for example recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A network system comprising:
a plurality of apparatuses which transmits traffic data included in a plurality of communications by switching a destination for each communication; and
a management device coupled to the plurality of apparatuses;
wherein each of the plurality of apparatuses comprises:
a processor which executes a first process comprising:
selecting a communication from a plurality of communications;
acquiring traffic data included in a selected communication selected in the selecting; and
transmitting a acquired traffic data acquired in the acquiring to the management device,
and wherein the management device comprises:
a processor which executes a second process comprising:
receiving the acquired traffic data from each of the plurality of apparatuses; and
performing an analysis of the selected communication based on the acquired traffic data.

2. The network system according to claim 1, wherein the selected communication is specified based on a source address and a destination address of the communication.

3. The network system according to claim 1, wherein the first process comprises:
generating a random number value in accordance with a given sampling rate;
wherein the selecting the communication is to select the communication based on the random number value.

4. The network system according to claim 1, wherein the first process comprises:
when the traffic data includes communication connection control information that indicates start of the communication, deciding whether the communication to which the traffic data including the communication connection control information belongs is decided to be sampled.

5. The network system according to claim 1, wherein the acquiring traffic data included in the selected communication is to capture all of traffic data included in the selected communication.

6. The network system according to claim 1, wherein the second process comprises:
detecting a communication where a congestion has occurred, from the plurality of communications based on the analysis.

7. The network system according to claim 6, wherein the second process comprises:
detecting an apparatus positioned on a communication path of the communication where the congestion has occurred, and
changing the communication path so as to bypass the apparatus.

8. The network system according to claim 1, wherein the first process comprises:
appending marking information to the acquired traffic data, the marking information indicating that the acquired traffic data is included in the selected communication.

9. The network system according to claim 8, comprising:
a plurality of switches, which are coupled to the management device, configured to receive traffic data transmitted from the plurality of apparatuses and to transmit the received traffic data by switching a destination for each of the communications;
wherein each of the plurality of switches comprises:
a processor which executes a third process comprising:
determining whether the received traffic data has been appended with the marking information,
capturing traffic data to which the marking information has been appended, and
transmitting the captured traffic data to the management device.

10. The network system according to claim 9, wherein the third process comprises:
determining whether the received traffic data is the acquired traffic, based on the marking information.

11. An apparatus comprising:
a memory which stores a program;
a processor which executes, based on the program, a process comprising:
selecting a communication from a plurality of communications;
acquiring traffic data included in a decided communication decided in the selecting; and
transmitting a acquired traffic data acquired in the acquiring to a management device.

12. The apparatus according to claim 11, wherein
the selected communication is specified based on a source address and a destination address of the communication.

13. The apparatus according to claim 11, wherein the process comprises:
generating a random number value in accordance with a given sampling rate;
wherein the selecting the communication is to select the communication based on the random number value.

14. The apparatus according to claim 11, wherein the process comprises:
when the traffic data includes communication connection control information that indicates start of the communication, deciding whether the communication to which the traffic data including the communication connection control information belongs is decided to be sampled.

15. The apparatus according to claim 11, wherein the acquiring traffic data included in the selected communication is to capture all of traffic data included in the selected communication.

16. The apparatus according to claim 11, wherein the process comprises:
appending marking information to the acquired traffic data, the marking information indicating that the acquired traffic data is included in the selected communication.

17. An apparatus comprising:
a memory which stores a program;
a processor which executes, based on the program, a process comprising:
selecting a communication from a plurality of communications;
receiving traffic data included in the plurality of communications;
transmitting the received traffic data by switching an apparatus serving as a destination for each of the communications;
determining whether the received traffic data has been appended with marking information indicating that the traffic data is included in the communication;
acquiring traffic data to which the marking information has been appended; and
transmitting the acquired traffic data to a management device.

18. The apparatus according to claim 17, wherein the process comprises:
determining whether the received traffic data is the acquired traffic, based on the marking information.
